(19) United States
(12) Patent Application Publication
(10) Pub. No.: US 2015/0039279 A1
(43) Pub. Date: Feb. 5, 2015

(54) SYSTEMS AND METHODS FOR MODELING A COMPLEX SYSTEM USING ABRIDGED PETRI NETS

(71) Applicant: Vitali Volovoi, Alpharetta, GA (US)

(72) Inventor: Vitali Volovoi, Alpharetta, GA (US)

(21) Appl. No.: 14/449,509

(22) Filed: Aug. 1, 2014

Related U.S. Application Data
(60) Provisional application No. 61/861,539, filed on Aug. 2, 2013.

(51) Int. Cl. G06F 17/50

(52) U.S. Cl. CPC G06F 17/5013
USPC 703/2

(57) ABSTRACT

A new graphical framework, Abridged Petri Nets (APNs) for modeling the dynamics of complex nondeterministic systems using a software implementation, is disclosed. APNs are similar to Stochastic Petri Nets (SPNs) and rely on component-based representation of system state space. Tokens (denoted as small circles) represent individual entities comprising the system; however, SPN graphs contain two kinds of nodes (called places and transitions) with transitions serving the purpose of routing tokens among places, so that a pair of place nodes can be linked to each other only via a transient stop, a transition node. In contrast, APN graphs link place nodes directly by arcs (transitions) and separate transition nodes are not needed. Tokens in APN are distinct and have labels that can assume both discrete (colors) and continuous (ages) values, and those values can change during simulation. Component interactions are modeled in APNs using triggers, which are either inhibitors that are also used in SPNs, or the inhibitors' opposites, enablers. Hierarchical constructions of APNs rely on using stacks (layers) of submodels with automatically matching color policies.

### TECHNICAL FIELD

This disclosure relates generally to complex systems and methods to model such systems, and more particularly, to the extension and simplification of Stochastic Petri Nets (SPNs) and Colored Petri Nets (CPNs).

The disclosure also relates to methods and systems for creating a model of a complex system using Abridged Petri Nets (APN).

The disclosure also relates to methods and systems for managing the behavior of a complex system having multiple entities.

The disclosure also relates to methods and systems for transforming a complex system using APNs.

The disclosure also relates to methods and systems for displaying a graphical representation of a complex system.

### BACKGROUND

Markov chains. State-space diagrams provide a convenient graphical way of depicting the behavior of non-deterministic systems. Markov chains are the simplest and most popular kind of state-space diagrams, with applications ranging from their original use by Andrey Markov (for modeling relative frequencies of vowels and consonants in Alexander Pushkin's novel “Eugene Onegin”) to evaluating web page ranks (in the PageRank algorithm invented by Google's founders). Despite their deserved popularity, Markov chains are prone to the “state-space explosion” they scale poorly as the number of components that comprise the system increases.

A simple example that illustrates this issue, is a household consisting of two family members (later referred to as customers) m1 and m2, and a car c1. Each customer can be in one of three states: not needing a car (N), driving a car (D), or waiting for a car (W); one may assume that being a passenger in the car qualifies as state N. First, consider a situation where the car can be in one of two states: idle (I) or used (U).

This “system” consists of three entities (two customers and a car), so there are 3×3×2=18 possible permutations of the components' states that can define the state the entire system. However, not all of those permutations constitute feasible system states, so a Markov model would have only five rather than 18 states. FIG. 1 shows the corresponding Markov chain diagram. Here, the state of each entity is represented by the corresponding capital letter (so, for example, the DNU state of the system implies that first customer is driving, the second is not needing the car, and the car is used). Introducing the possibility that the car can be broken (be in state B) extends the size of the diagram to nine states (as shown in FIG. 2). For a family with n customers and k cars, the number of system states can be calculated as follows: at any given time one can have 0≦m≦n members of the family who need cars (demand) and 0≦l≦k cars that are not broken (supply). For each m≦l the number of distinct states corresponds to the number of ways one can select m driving members of the family:

$$N ( m , l ) = ( \begin{matrix}n \\ m\end{matrix} ) ( \begin{matrix}l \\ k\end{matrix} ) .$$

If m>l then m−l members of the family are waiting for a car (i.e., in state W), so the corresponding number of states will be

$$N ( m , l ) = ( \begin{matrix}n \\ m\end{matrix} ) ( \begin{matrix}m \\ l\end{matrix} ) ( \begin{matrix}l \\ k\end{matrix} ) .$$

The total number of states will be given by the following formula:

$${\sum }_{m = 0}^{n} ( \begin{matrix}n \\ m\end{matrix} ) [ {\sum }_{l = 0}^{m - 1} ( \begin{matrix}m \\ l\end{matrix} ) ( \begin{matrix}l \\ k\end{matrix} ) + {\sum }_{l = m}^{k} ( \begin{matrix}l \\ k\end{matrix} ) ]$$

For a family of four with two cars, the number of possible states is 111 and for a family of five with three cars, that number is 589. If one considers a fleet of 10 cars with 20 customers, the number of states is 451,417,560,951, or over 451 billion.

This rapidly growing state-space size can be avoided using symmetry considerations, if the customers or the cars are not distinguished among themselves. Indeed, for two customers and one car the number of states reduces to three and six for FIGS. 1, 2, respectively, as states such as DNU and NDU can be merged together. However, very often one does want to track individual performance (Dad might need the car more often for longer trips, and Car A is old and breaks more often). On the other hand, the state space will be even larger if one wants to distinguish which car is driven by a given customer: if there are q cars driven at any given time, there are potentially q! possible combinations, although only some of those combinations might be feasible (for example, one can have a list of preferred cars for each member of the family and track how their preferences are satisfied).

Petri nets. The example above represents a general problem with customers generating service demand and cars representing entities (servers) that service (satisfy) the demand. The meaning of both customers and servers is domain-dependent. A partial, but not exhaustive, listing of those pairs includes:

Packets of information (customers) and computer servers or routers (servers) in computer applications

Tasks (customers) and resources (servers) in business processes

Callers (customers) and teller (servers) at the call centers

Passengers or freight (customers) and transportation and storage resources (servers) in logistics

As a result, matching demand and supply problems are at the core of modeling needs with Petri nets.

Since alphabetical notations based on the states of the components were used for identifying a system state, it is natural to employ some sort of graphical equivalent of an alphabet in graphical description of a system. Petri nets effectively implement this idea by modeling the states of individual components rather than the entire system. As shown in FIG. 3, in Petri nets 100, Markov chain-state diagrams are complemented by two new types of objects: first, small filled circles (called tokens 105) denoting individual components are introduced, each placed inside of one of the larger hollow circles (called places 110) that denote the potential states of those components (the latter entities are named “places” as opposed to “states” in Markov diagrams). Second, in order to model interactions among components, the tokens are routed among places via intermediate stops or junctures called transitions 115 that are denoted with solid rectangles. Two places 110 and 125 are connected by arcs 120 and 130 through a transition 115. The number of input and output arcs 120 does not need to coincide, enabling merging and splitting of token routes. The timing of state changes can be modeled by specifying time delays for transition “firing”: an action that removes tokens from all input places for the transition and deposits tokens into its output places. Such Petri nets are called timed Petri nets, or, more specifically, Stochastic Petri Nets (SPNs). Here the word “stochastic” refers to the fact that delays can be non-deterministic, and one may consider the associated distribution not to be limited to any particular type. FIG. 3 depicts an SPN for two customers and one car. Using standard notations for SPNs, thin rectangles denote immediate transitions that incur no delays.

The SPN in FIG. 3 consists of three groups corresponding to each component of the system, and if there are tokens in places “car needed” and “car available,” those two tokens are merged into a single token deposited into a place “car used.” This simple model reflects the fundamental feature of SPNs in modeling the coordinated behavior of system components: tokens that represent the car and the driver are merged into a single “car-driver” token while driving takes place, and split into separate tokens again when the driving is complete.

The model has eight states (places 110), but clearly the complexity of the model is determined not only by the number of places 110 but also by the number of transitions 115 (eight), connecting arcs 120 (20), and tokens 105 (3). In fact, this model does not take into account the possibility that the car can break while driving (so each trip is completed). To include this possibility, one needs to include two extra transitions as shown in FIG. 4. Now one may have ten transitions 115 and 26 arcs 120 (the corresponding Markov model has 23 arcs).

Such SPN models scale better than Markov chains (which explains the fact that they were originally used as a pre-processor for creating Markov chain models). Indeed, there would be three places required for each customer and two places for each car, so the number of places in the model with 20 customers and 10 cars would be only 80, which is certainly an improvement over 451 billion states. However, the web of connecting arcs will be so convoluted that the resulting model is still too complex to be of practical use for conveying the system behavior visually (referring back to FIG. 4, one can envision 20 segments of the net similar to the two depicted at the top of the net, and 10 segments similar to the one to the bottom, with each of the 10 segments at the bottom being connected to each of the 20 segments at the top).

Noting that subnets for each customer are similar; it is tempting to use only one of the subnets and represent each customer by a different token within the same net. At least two modifications are needed to enable such modeling:
1. Parallel processing of tokens by transitions: one needs to define the behavior of the net when there are multiple tokens in the same place. While some SPNs use “single-server” enabling (when tokens are enabled and fired one at a time), here one would need multiple enabling (or “infinite-server” to be precise), so that each token's eligibility for moving to a new place is assessed in parallel (since two customers certainly might want to drive a car simultaneously). While it is possible to have switching between single and multiple servers within the same framework, single servers can be easily represented using multiple servers, only multiple servers are used in the disclosed framework.
2. Colors: As discussed in the context of Markov chains, the state-space explosion is mostly caused by the desire to account for differences in component behavior. If a token representing a component is traveling within a distinct subnet, one can incorporate the differences by appropriately adjusting the properties of individual transitions for each subnet. Introducing colors to Petri nets allows for the transition properties to be color-dependent, and so components can maintain their differences while the corresponding tokens travel through the same portion of the net.

The resulting network is shown in FIG. 5. It looks more compact and scalable. However, implementing such a model requires a fairly complex definition of what “color” means. While the original concept of a token's color allowed for complex attributes to be assigned to tokens, it is desirable not to hide the model complexity inside of complex formulae that govern token colors. The simplest and most intuitively appealing implementation of “color” is an integer assigned to a token that can be visualized by the corresponding color, as depicted in FIG. 5.

However, the merging and splitting of tokens at transitions create bookkeeping difficulties in terms of tracking individual tokens' identities identified in FIG. 5 as a circle with a number (colors). For example, when the car is used, there is a token that represents the first customer using the car, and the following transition should know the difference to restore the token that represents the customer (and route it to the top place). If one has multiple cars and family drivers, the permutations will multiply—effectively leading to the same type of “global” problem of state-space explosion that one tried to avoid in the first place, which would need to be resolved by complex rules governing merging and then splitting back colors.

Petri Nets and their concepts have been applied in a variety of areas, including Office automation, work-flows, flexible manufacturing, programming languages, protocols and networks, hardware structures, real-time systems, performance evaluation, operations research, embedded systems, defense systems, telecommunications, Internet, e-commerce and trading, railway networks, biological systems.

### BRIEF DESCRIPTION OF THE INVENTION

The disclosure provides a solution to the problem of the state-space size in the modeling of complex systems.

In accordance with one exemplary non-limiting embodiment, the invention relates to a method for modeling nondeterministic time-dependent behavior of a complex system that are comprised of multiple entities, the method implemented by a computer comprises defining at least two states of the complex system. The method includes producing a graphical representation of the at least two states of the complex system depicted by at least one graph using the computer. The step of producing a graphical representation includes defining at least two places; generating a graphical representation of the at least two places that describe possible states of the multiple entities that comprise the complex system; depicting a token that is located inside of one of the at least two places thereby denoting a current realization of one of the at least two places for an entity represented by the token; and depicting a first directed arc that directly connects two of the at least two places and facilitate possible movements of tokens in a direction of the first directed arc. The method also includes performing a performance analysis of the model and system.

In another embodiment, a system for modeling nondeterministic time-dependent behavior of a complex system that is comprised of multiple entities. The system includes a computer. The system also includes a graphical representation subsystem that produces, by the computer, a graphical representation of at least two states of the system depicted by at least one graph. The graphical representation subsystem includes an APN subsystem that: describes at least two places representing possible states of the multiple entities that comprise the complex system; locates a first token inside of one of the at least two places thereby denoting a current realization of one of the possible states for one of the multiple entities represented by the first token; and directly connects at least one directed arc to two of the at least two places and facilitate possible movements of the first token in a direction of the said arc. The system also includes a subsystem that performs a performance analysis of the model and the complex system.

In another embodiment, a non-transitory computer readable medium is provided. The computer readable medium is encoded with a program, when executed by a processor, performing a method for processing content information in an online environment. The method includes producing a graphical representation of at least two states of a system depicted by at least one graph using the processor. The step of producing a graphical representation comprises: generating a graphical representation of at least two places that describes possible states of multiple entities that comprise the system; depicting a token that is located inside of one of the at least two places thereby denoting a current realization of one of the at least two states for an entity represented by the token. and the method further includes depicting a first directed arc that directly connects two of the at least two places and facilitates possible movements of tokens in a direction of the first directed arc. The method implemented by the computer readable medium also includes performing a performance analysis of the model and the complex system.

In accordance with one exemplary non-limiting embodiment, the invention relates to a method for determining the performance of a nondeterministic time-dependent behavior of a complex system that are comprised of multiple entities, the method implemented by a computer comprises defining at least two states of the complex system. The method includes producing a graphical representation of the at least two states of the complex system depicted by at least one graph using the computer. The step of producing a graphical representation includes defining at least two places; generating a graphical representation of the at least two places that describe possible states of the multiple entities that comprise the complex system; depicting a token that is located inside of one of the at least two places thereby denoting a current realization of one of the at least two places for an entity represented by the token; and depicting a first directed arc that directly connects two of the at least two places and facilitate possible movements of tokens in a direction of the first directed arc. The method also includes performing a performance analysis of the model and system.

In another embodiment, a system for determining the performance of a nondeterministic time-dependent behavior of a complex system that is comprised of multiple entities is presented. The system includes a computer. The system also includes a graphical representation subsystem that produces, by the computer, a graphical representation of at least two states of the system depicted by at least one graph. The graphical representation subsystem includes an APN subsystem that: describes at least two places representing possible states of the multiple entities that comprise the complex system; locates a first token inside of one of the at least two places thereby denoting a current realization of one of the possible states for one of the multiple entities represented by the first token; and directly connects at least one directed arc to two of the at least two places and facilitate possible movements of the first token in a direction of the said arc. The system also includes a subsystem that performs a performance analysis of the model and the complex system.

In accordance with one exemplary non-limiting embodiment, the invention relates to a method for using a digital computer to transform a complex system having a plurality of entities. The method includes the steps of creating a model of the complex system by defining at least two states of the complex system. The method also includes the step of producing a graphical representation of the at least two states of the complex system depicted by at least one graph. The step of producing a graphical representation of the at least two states includes the steps of defining at least two places; generating a graphical representation of the at least two places that describes possible states of the plurality of entities that comprise the complex system, and depicting a token that is located inside of one of the at least two places thereby denoting a current realization of one of the at least two places for an entity represented by the token. The method further includes depicting a first directed arc that connect two of the at least two places and facilitate possible movements of tokens in a direction of the first directed arc. The method further includes the step of performing a performance analysis of the model of the complex system. The method further includes the steps of directing a change in the complex system based on the performance analysis.

In accordance with one exemplary non-limiting embodiment, the invention relates to a system for transforming a complex system having a plurality of entities. The system includes a computer and a subsystem that creates a model of the complex system by defining at least two states of the complex system. The system also includes a subsystem that produces a graphical representation of the at least two states of the complex system depicted by at least one graph. The subsystem that produces a graphical representation of the at least two states includes subsystems that perform the steps of defining at least two places; generating a graphical representation of the at least two places that describes possible states of the plurality of entities that comprise the complex system; and depicting a token that is located inside of one of the at least two places thereby denoting a current realization of one of the at least two places for an entity represented by the token. The subsystem that produces a graphical representation further performs the step of depicting a first directed arc that directly connects two of the at least two places and facilitate possible movements of tokens in a direction of the first directed arc. The system further includes a subsystem that performs a performance analysis of the model of the complex system, and a subsystem that; directs a change in the complex system based on the performance analysis of the model of the complex system.

In accordance with one exemplary non-limiting embodiment, the invention relates to non-transitory computer readable media that when executed transforms a complex system having a plurality of entities. The computer readable media includes instructions to create a model of the complex system by defining at least two states of the complex system. The computer readable media also includes a instructions to produce a graphical representation of the at least two states of the complex system depicted by at least one graph. The instructions to produce a graphical representation of the at least two states includes instructions to define at least two places and generate a graphical representation of the at least two places that describes possible states of the plurality of entities that comprise the complex system; depict a token that is located inside of one of the at least two places thereby denoting a current realization of one of the at least two places for an entity represented by the token. The instructions further include instructions to depict a first directed arc that directly connects two of the at least two places and facilitates possible movements of tokens in a direction of the first directed arc. The computer readable media further includes instructions to perform a performance analysis of the model of the system; and instructions to direct a change in the complex system based the performance analysis of the model.

In accordance with one exemplary non-limiting embodiment, the invention relates to a method for managing a nondeterministic time-dependent behavior of a complex system having multiple entities. The method includes the steps of creating a model of the complex system by defining at least two states of the complex system and producing a graphical representation of the at least two states of the complex system depicted by at least one graph using a computer. The step of producing a graphical representation includes the steps of defining at least two places; generating a graphical representation of the at least two places that describes possible states of the multiple entities that comprise the complex system; and depicting a token that is located inside of one of the at least two places thereby denoting a current realization of one of the at least two places for an entity represented by the token. The step of producing a graphical representation further includes depicting a first directed arc that directly connects two of the at least two places and facilitates possible movements of tokens in a direction of the first directed arc. The method for managing the nondeterministic time-dependent behavior of a complex system also includes the steps of performing a performance analysis of the model of the complex system. The method for managing the nondeterministic time-dependent behavior of a complex system also includes the steps of transforming the complex system based on the performance analysis of the model of complex system.

In accordance with one exemplary non-limiting embodiment, the invention relates to a system for managing a nondeterministic time-dependent behavior of a complex system having multiple entities. The system includes a computer and a subsystem that creates a model of the complex system includes a subsystem that defines at least two states of the complex system and produces a graphical representation of the at least two states of the complex system depicted by at least one graph using the computer. The subsystem that produces a graphical representation includes a subsystem that defines at least two places; generates a graphical representation of the at least two places that describes possible states of the multiple entities that comprise the complex system; depicts a token that is located inside of one of the at least two places thereby denoting a current realization of one of the at least two places for an entity represented by the token; and depicts a first directed arc that directly connects two of the at least two places and facilitates possible movements of tokens in a direction of the first directed arc. The system for managing the nondeterministic time-dependent behavior of a complex system also includes a subsystem that performs a performance analysis of the model of the complex system; and generates software source code that simulates the model of the complex system. The system for managing the nondeterministic time-dependent behavior of a complex system also includes a subsystem that transforms the complex system based on the performance analysis of the complex system.

In accordance with one exemplary non-limiting embodiment, the invention relates to non-transitory computer readable medium for managing a nondeterministic time-dependent behavior of a complex system having multiple entities. The computer readable medium includes instructions to create a model of the complex system comprising instructions to define at least two states of the complex system and produce a graphical representation of the at least two states of the complex system depicted by at least one graph using the computer. The instructions to produce a graphical representation includes a instructions to define at least two places; generate a graphical representation of the at least two places that describes possible states of the multiple entities that comprise the complex system; depict a token that is located inside of one of the at least two places thereby denoting a current realization of one of the at least two places for an entity represented by the token; and depict a first directed arc that directly connects two of the at least two places and facilitates possible movements of tokens in a direction of the first directed arc. The computer readable medium also includes instructions to perform a performance analysis of the model of the complex system. The computer readable medium also includes instructions to transform the complex system based on the performance analysis of the complex system.

In accordance with one exemplary non-limiting embodiment, the invention relates to a method for displaying a graphical representation of a complex system. The method includes the steps of defining at least two states of the complex system. The method further includes producing a graphical representation of the at least two states of the complex system depicted by at least one graph using the computer. The step of producing a graphical representation includes defining at least two places, and generating a graphical representation of the at least two places that describes possible states of the multiple entities that comprise the complex system. The step of producing a graphical representation further includes depicting a token that is located inside of one of the at least two places thereby denoting a current realization of one of the at least two places for an entity represented by the token. The step of producing a graphical representation further includes depicting a first directed arc that directly connects two of the at least two places and facilitates possible movements of tokens in a direction of the first directed arc. The method may further include the step of performing a performance analysis of the complex system and displaying the graphical representation of the complex system on a computer screen.

In accordance with one exemplary non-limiting embodiment, the invention relates to a system for displaying a graphical representation of a complex system. The system includes a computer and a subsystem that defines at least two states of the complex system. The system further includes a subsystem that produces a graphical representation of the at least two states of the complex system depicted by at least one graph using the computer. The subsystem that produces a graphical representation includes a subsystem that defines at least two places, and generates a graphical representation of the at least two places that describes possible states of the multiple entities that comprise the complex system. The subsystem that produces a graphical representation further includes a subsystem that depicts a token that is located inside of one of the at least two places thereby denoting a current realization of one of the at least two places for an entity represented by the token. The subsystem that produces a graphical representation further includes a subsystem that depicts a first directed arc that directly connects two of the at least two places and facilitates possible movements of tokens in a direction of the first directed arc. The system may further include a subsystem that performs a performance analysis of the complex system and displays the graphical representation of the complex system on a computer screen.

In accordance with one exemplary non-limiting embodiment, the invention relates to a non-transitory computer readable medium encoded with a program, when executed by a processor, performing a method for modeling a complex system. The method includes the steps of defining at least two states of the complex system. The method further includes producing a graphical representation of the at least two states of the complex system depicted by at least one graph using the computer. The step of producing a graphical representation includes defining at least two places, and generating a graphical representation of the at least two places that describes possible states of the multiple entities that comprise the complex system. The step of producing a graphical representation further includes depicting a token that is located inside of one of the at least two places thereby denoting a current realization of one of the at least two places for an entity represented by the token. The step of producing a graphical representation further includes depicting a first directed arc that directly connects two of the at least two places and facilitates possible movements of tokens in a direction of the first directed arc. The method may further include the step of performing a performance analysis of the complex system and displaying the graphical representation of the complex system on a computer screen.

### BRIEF DESCRIPTION OF THE DRAWINGS

Other features and advantages of the present invention will be apparent from the following more detailed description of the preferred embodiment, taken in conjunction with the accompanying drawings which illustrate, by way of example, the principles of certain aspects of the invention.

FIG. 1 is a schematic illustrating a prior art example of a Markov chain diagram for two customers and one car.

FIG. 2 is a schematic illustrating a prior art example of a Markov chain diagram for two customers and one car, including the possibility that the car is broken.

FIG. 3 is a schematic illustrating a prior art example of a Stochastic Petri net diagram for two customers and one car, where the car is assumed not to break during trips.

FIG. 4 is a schematic illustrating a prior art example of a Stochastic Petri net diagram for two customers and one car, including the additional possibility that the car can also break during the trip.

FIG. 5 is a schematic illustrating a prior art example of a colored stochastic Petri net diagram for two customers and one car.

FIG. 6 is a schematic illustrating an embodiment of an Abridged Petri net diagram for two customers and one car, in accordance with the present invention.

FIG. 7 is a schematic illustrating an embodiment of an alternative modeling using an Abridged Petri Net diagram for two customers and one car in accordance with the present invention.

FIG. 8 is a schematic illustrating an embodiment of an Abridged Petri Net diagram for five customers and three cars in accordance with the present invention.

FIG. 9 is a schematic illustrating an embodiment of an Abridged Petri Net diagram for a method for periodic inspection.

FIG. 10 is a schematic illustrating an embodiment of an Abridged Petri Net diagram for a method for periodic inspection.

FIG. 11 is a schematic illustrating an embodiment of an Abridged Petri Net diagram for a method for queuing.

FIG. 12 is a schematic illustrating an embodiment of an Abridged Petri Net diagram for a method for queuing.

FIG. 13 is a schematic illustrating an embodiment of an Abridged Petri Net diagram for a method for air traffic control.

FIG. 14 is a schematic illustrating an embodiment of an Abridged Petri Net diagram for a method for air traffic control.

FIG. 15 is a schematic illustrating an embodiment of an Abridged Petri Net (APN) diagram for a method for processing complaints.

FIG. 16 is a schematic illustrating an embodiment of an Abridged Petri Net (APN) diagram for multiple cars and customers while tracking specific pairing of customers with the service, in accordance with the present invention.

FIG. 17 is a schematic illustrating an embodiment of an Abridged Petri Net (APN) diagram for multiple cars and customers while tracking specific pairing of customers with the service, in accordance with the present invention.

FIG. 18 is a schematic illustrating an embodiment of an Abridged Petri Net (APN) diagram for multiple cars and customers while tracking specific pairing of customers with the service, in accordance with the present invention.

FIG. 19 is a schematic illustrating an embodiment of an Abridged Petri Net (APN) diagram for multiple cars and customers while tracking specific pairing of customers with the service, in accordance with the present invention.

FIG. 20 is a schematic illustrating an embodiment of a general representation of the color shift model using Abridged Petri Nets in accordance with the present invention.

FIG. 21 is a schematic illustrating an embodiment of an Abridged Petri Net diagram for a medical office model (a snapshot is made in the beginning of the simulation) in accordance with the present invention.

FIG. 22 is a schematic illustrating an embodiment of an Abridged Petri Net diagram for a medical office model (a snapshot is made during the simulation) in accordance with the present invention.

FIG. 23 is an APN diagram of an example a family of two that share a car.

FIG. 24 is graph showing the results using a simulation where randomness is introduced into the model and transitions are assigned exponential delays.

FIG. 25 is graph showing the results using a simulation where demand delay is fixed, and the trip duration is exponential.

FIG. 26 is graph showing the results using a simulation where exponential distribution is used for the demand and there is a fixed trip duration.

FIG. 27 is an alternate APN model including the possibility of a car breaking.

FIG. 28 is a graph showing the results of a case where a car breaks in accordance with an exponential distribution and it is restored after fixed delay.

FIG. 29 is an APN model showing the effects of pooling of resources.

FIG. 30 is a graph showing the results of a simulation where the resources are pooled.

FIG. 31 is an APN model modeling a visit to a clinic.

FIG. 32 is a graph showing the results of a simulation where the total number of customers is 200 and the simulations are run first using exponential distribution and then with log normal distribution.

FIG. 33 is a flowchart of a method in accordance with one embodiment of the present invention.

FIG. 34 is a functional block diagram of a general purpose computer.

### DETAILED DESCRIPTION OF THE INVENTION

Glossary

“Assign” means to allocate, designate, name, or specify.

“Changing” means to make the form, nature, content, future course, or position, of (something) different from what it is or from what it would be if left alone.

“Color” means an integer data value attached to a token.

“Complex System” is a system consisting of many diverse and autonomous but interrelated and interdependent components or parts linked through many (dense) interconnections. Complex systems cannot be described by a single rule and their characteristics are not reducible to one level of description. They exhibit properties that emerge from the interaction of their parts and which cannot be predicted from the properties of the parts unless the interactions among the parts are properly accounted for. Examples of complex systems include an Electrical Power grid that consists of the means of power generation, transmission, and distribution, or a national airspace system that is comprised of air traffic controllers, airlines, etc.

“Continuous Label” means a real data value attached to a token.

“Depict” means to represent by displaying such as on a computer screen.

“Directed Arc” is an arc that connects two graphical objects of a graph in a defined order that indicates the direction of the changes with time. For a prior art Petri nets a directed arc connects a place with a transition or a transition with a place. For the abridged Petri nets a directed arc directly connects two places of the graph.

“Directing” means to give instructions, command, or order.

“Directly” means in a way that involves only the two things mentioned, with nothing else coming in between, i.e. without an intervening transition.

“Discrete Label” is the same as Color (see above)

“Entity” is a part of the modeled system that has a real existence; can undergo changes that are relevant to the system behavior; and are represented as the lowest atomic (non-divisible) unit of modeling called tokens. Examples of entities include physical objects, such as cars, trains, people, organisms, proteins, molecules, as well as conditions such as day or night, rain, humidity, temperature, etc. The choice of the entities depends on the modeling objectives, for example, for some models a car can be considered a single entity, while for detailed modeling of interactions within a single car, individual entities can correspond to an air-bag, an ignition system, etc.

“Facilitate” means to make it possible or easier for something to happen.

“Firing” represents an occurrence of the event or an action taken corresponding to a discrete change of a state of an entity, for example, when entity “car” changes from “operational” to “broken”, which is modeled by moving the token representing the car from the “operational” place to the “broken” place.

“Fused places” are places that are shown graphically as distinct to facilitate the visual clarity of the model but are treated as a single place for the analysis purposes.

“Layer” is an individual element of the stack arrangement, for example in modeling a supply chain with multiple front shops and a single depot; a front shop can represent a layer.

“Non-Deterministic” means an algorithm, model, procedure, process, etc., whose resulting behavior is not entirely determined by its initial state and inputs, and which may be random or stochastic. Processes or projects having only one outcome are said to be deterministic and their outcome is ‘pre-determined.’ A deterministic algorithm, for example, if given the same input information will always produce the same output information. For example, a non-deterministic algorithm is an algorithm that can exhibit different behaviors on different runs (like flipping a coin).

“Performance analysis” represents a qualitative or quantitative analysis of the model representing a system that provides insights into the system behavior. Performance analysis can be conducted by means of discrete-event simulations, differential equations, or other appropriate mathematical means that describe the system. For example, when modeling operation of a doctor's office one can evaluate the expected waiting time for a patient or the number of patients served.

“Place” represents a possible state of an entity, for example for an entity representing a species there could be the following places: Vulnerable, Endangered, and Extinct. Positioning a token representing the entity inside the place at a certain time indicates that for that particular entity at that particular time that particular state holds true (Snow Leopard token is in Endangered Place at the current time).

“Realization” means that out of a given set of possible states for an entity a particular one is held true in a particular instance. This is represented by positioning a corresponding token inside the appropriate place that corresponds to the realized state for this entity represented by the token.

“State” means the condition of an entity with respect to circumstances or attributes that is relevant to the overall system behavior, for example . . . a train can be moving or stopped.

“Subnet” means a part of the total graph (net) treated as a whole and represented separately, for example shown or hidden from the view.

“System” means an assemblage or combination of things or parts forming a complex or unitary whole, for example a car consists of an engine, transmission, wheels, etc. combined to provide a means of personal transportation. The state of the system at any given time is fully described by the states of the contributing parts.

“Page” represents a distinct view of the total net that might have some subnets shown and some hidden.

Sensor is an attribute of a place that specify whether and which statistics is collected about the tokens that are located in this place.

“Stack” is a particular arrangement of subnets that explores the third dimension (depth) of the net. Individual subnets (usually representing similar but distinct subnets) are arranged from the top to bottom, so that only the top subnet (layer) can be viewed and accessed.

“Token” is a variable (dynamic) element of a Petri net; indicated by dots or other appropriate symbols (e.g., car, airplane, etc.) that represent a modeled atomic entity. Each token has a set of places where it can potentially be located (token must be in one of those places and it cannot be in two places at the same time).

“Transition” is an event or action which causes a change of state, for example biochemical reactions, dissociation/association, state shifts, actions, molecular changes, transport/diffusion and the like. This change is represented in the net by a directed arc that originates in the incoming place and terminates in the outgoing place. When the event or action occurs the transition “fires” (moves) a token from the incoming to the outgoing place.

“Transform” means to change in form, appearance, structure, condition or position.

“Trigger” is a means to represent an interaction (dependence) among the entities that comprise the system. In particular, triggers provide a mechanism for inhibiting or enabling the possibility of state transitions of some entities based on particular states of some other entities. Trigger is an arc that originates at a place and terminates at a transition. If the tokens located at the originating place satisfy the condition specified as the trigger attribute then transition gets either disabled or enabled (depending on whether the token is inhibitor or enabler, respectively). For example, presence of token in a place indicating that a certain drug is administered might trigger the change of state of the targeted entity (e.g., the disease process is slowed down).

Embodiments of the invention provide a different approach that avoids the above mentioned difficulties of tracking individual tokens through transitions. If tokens are unique, then in order to simplify the tracking of tokens through transitions one allows only a single input and single output through a transition. As a result, the need for separate nodes that constitute junctures for routing nodes among places is eliminated, and places can be directly connected by arcs. Interaction among different entities in the system is modeled using so-called triggers that include a well-known construct called inhibitors, and their opposites, enablers.

Inhibitors provide a “zero test” capability and are known to increase the modeling power of Petri nets to that of a Turing machine. They are depicted as arcs originating at a place and terminating at a transition with a hollow circle. An inhibitor of multiplicity k disables a transition at which it terminates if the number of tokens in its input place is at least k. An enabler (depicted as an arc originating at a place and terminating at a transition with a filled circle) is defined in the opposite way: a transition is disabled unless an enabler of multiplicity k has at least k tokens in its input place. It can be shown that the combination of enablers and inhibitors with direct transitions between places allows the modeling of any system that can be modeled using Petri nets with multiple inputs and outputs to a transition (in other words, the modeling power is not reduced).

SPNs that use transitions as hubs for routing tokens as the main mechanism for modeling component interdependence, and SPNs that use triggers (mainly inhibitors) as a supplementary tool for modeling the interdependence are known. However, the disclosed network is the first one that relies solely on the triggers, and as a result can dispose of the hubs and connect places directly.

As a result, a framework that looks like a hybrid between traditional Markov chain-state charts and Petri nets is introduced: transitions connect places directly (like in Markov chains) but tokens are present that have discrete labels (colors) as well as continuous labels (age). As shown below, when combined with hierarchical construction capabilities, the resulting framework provides compact and visual representation of complex interactions in large-scale systems. The resulting framework is referred to as “Abridged Petri Nets (APNs)”.

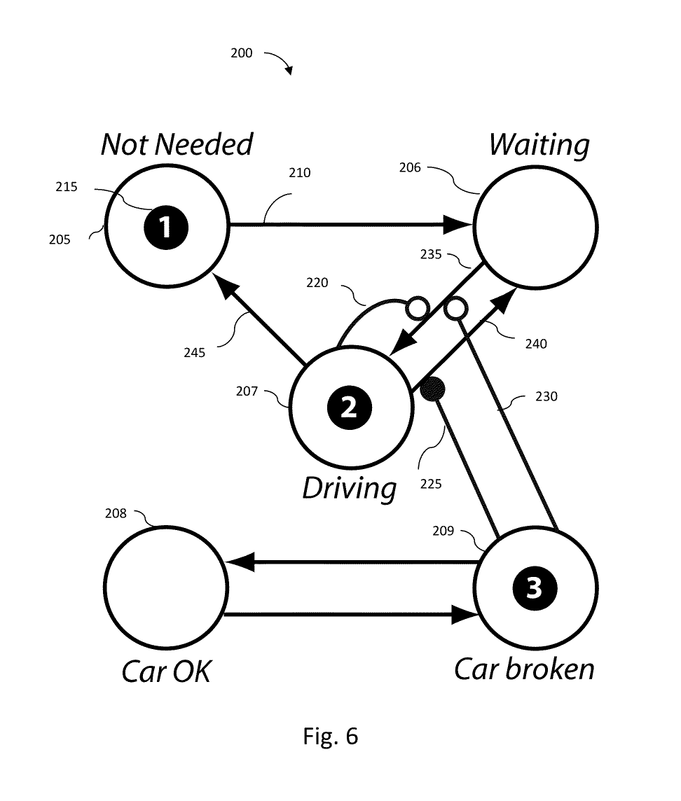

1. As illustrated in FIG. 6, an APN 200 is defined as a network of places 205, 206, 207, 208, and 209 (denoted as hollow large circles) that are directly connected by directed arcs (e.g. transitions 210). Changes in the system's state are modeled by transition firing: i.e., moving a token 215 from the transition input place (e.g. 205) to its output place (e.g. 206). The combined position of tokens in the net at any given moment of time represents marking of the net and fully specifies the modeled system.

2. Each transition 210 has no more than a single input and single output place (a transition can have no input place, providing a source of new tokens 215 every time it fires, and can have no output place, providing a sink for tokens 215: upon firing of such a transition, a token 215 is removed from the net).

3. Each token 215 can have a discrete label (color) (shown as a number in FIG. 6) that can change when token 215 moves. In addition, tokens 215 have continuous labels (ages) that can change both when tokens move, and with the progression of time while a token stays in the same place.

4. A transition 210 is enabled or disabled based on the combined marking of the input places of the associated triggers (inhibitors 220 and enablers 225) Inhibitors 220 are depicted as arcs originating at a place and terminating at a transition with a hollow circle. An inhibitor of multiplicity k disables a transition that it terminates at if the number of tokens in its input place is at least k. An enabler 225 (depicted as an arc originating at a place and terminating at a transition with a filled circle) is opposite to an inhibitor 220: a transition is disabled unless an enabler 225 of multiplicity k has at least k tokens in its input place. Triggers can be color-specific (and therefore enable only tokens in a place of a certain color, or act only if there are a specified number of tokens of a given color in their respective input places, or both).

5. Transitions 210 have color- and age-dependent policies that specify the delay between the moment when the token 215 is enabled and it is “fired.” If a token-transition pair is enabled, a firing delay is specified based on the combination of the properties of token 215 and transition 210. If token 215 stays enabled throughout the delay, after this delay expires the token 215 is “fired.” If there are multiple enabled tokens 215 in the same place, they all can participate in the firing “race” in parallel. Similarly, the same token 215 can be involved in a race with several transitions 210. If a token-transition pair is disabled, the firing is preempted (however, the aging label of the token can change as a result).

6. The delays can be deterministic (including zero delay) or follow any specified random distributions.

7. The performance of the system is based on the statistical properties of the marking and can be evaluated using discrete-event simulation or differential equations (including but not limited to finite-difference solutions).

8. Hierarchical constructions for combining multiple subnets are used to model large-scale systems. In particular, automatic generation of layers of multiple pages that contain similar but possible distinct subnets is facilitated.

9. In particular, an automatic “color shift” is used to differentiate between the tokens 215 from a given layer and ensure that the tokens enter the desired layer when needed.

### EXAMPLE 1

FIG. 6 depicts an APN model for the car example discussed above. An inhibitor 220 originates at the “Driving” place, preventing two tokens from appearing in that place simultaneously (if one person drives, the other cannot drive the same car). An additional inhibitor 230 that originates at the place “Car broken” also terminates in that transition 235 (if the car is broken, the customer cannot drive the car). Finally, if a customer drives a car (so there is a token in the place “Driving”), and the car breaks (a token moves into place “Car broken”), then the enabler 225 activates the immediate transition 240 from “Driving” to “Waiting.” In contrast, if the car is operational throughout the trip, the transition 245 from the “Driving” place to “Not needed” is fired (the duration of the trip is specified in the delay of this transition).

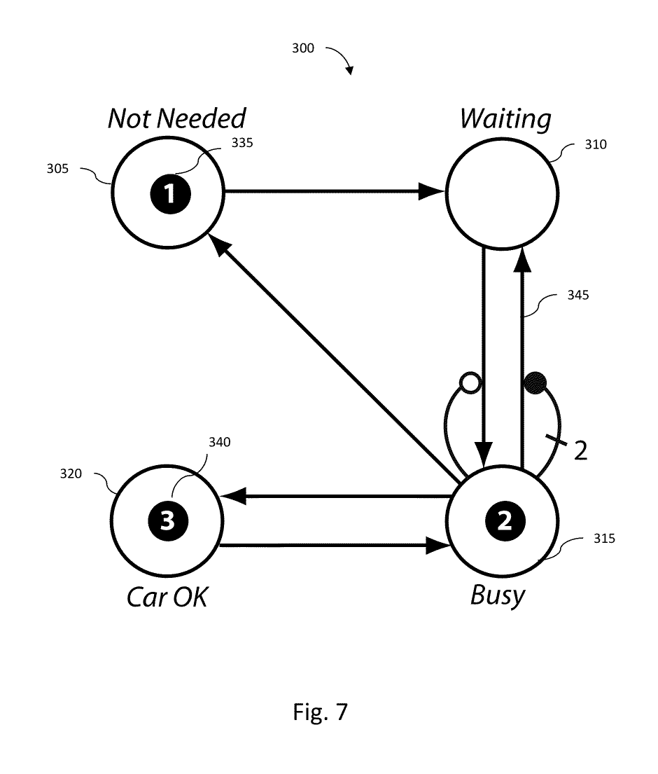

An alternative model 300 of the same process is shown in FIG. 7, demonstrating the flexibility of the disclosed modeling framework. The number of places 305, 310, 315 and 320 is reduced to four by noting that both a broken car or a driven car make that car unavailable, and so it is possible to merge the corresponding two places into the “Busy” place. Here color-specific policies of transitions ensure that the token representing the driver 335 will return to the “Not needed” place 305 when the trip is completed, while the token representing the car 340 will return to the “Car OK” place 320 when the repair is completed. However, while those tokens (e.g. token 340) are in the “Busy” place, they all play the same role by displacing the token that corresponds to driving.

One can use the same model for as many customers as needed. If there is more than one car, the model (after adjusting the appropriate trigger multiplicities, as shown below) can also work correctly if customers have predetermined priorities, so that a customer with the higher priority can swap a broken car for a working one, and a customer with the lowest priority will end up waiting for an available car regardless of which car breaks. The priorities are implemented by specifying small-fixed time delays for the transition 345 from the “Busy” place 315 to the “Waiting” place 310 ordered in such a way that a customer with lower priority has a smaller delay, and so the token of the corresponding color will be fired first.

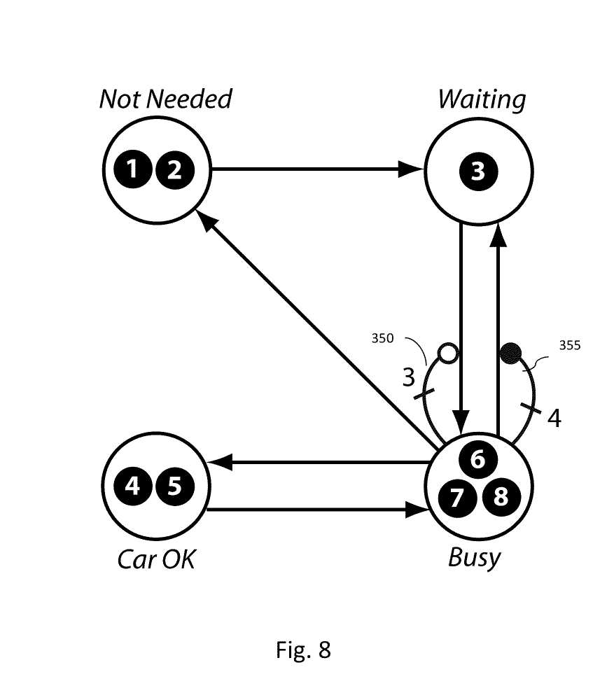

For example, consider a situation illustrated if FIG. 8, where m=3 cars and k=5 customers, denoted with tokens of colors 1 . . . k ordered in such a way that the higher priority customer have higher-valued colors. The multiplicity of the inhibitor 350 is m (not allowing more than three tokens in the place) and the multiplicity of the enabler 355 is m+1—initiating the removal of a token if it is “extra.” Then by assigning small fixed delays for the transition from the “Busy” place 325 to the “Waiting” place 320, so that for each i the corresponding delay is iε, one ensures that correct priorities are observed (in an alternative implementation, those transitions can be explicitly specified as immediate with the possibility of specifying explicit priorities, the end result is effectively identical).

While this model is compact and relatively simple, it does not provide the resolution for tracking a specific pairing between the customers and the cars. This might be desirable if swapping of the cars in the middle of the trip is not allowed, and one wants to track which customers' trips got interrupted. In order to implement this aspect of behavior of the modeled system, one needs to introduce a special place for each pairing. Since the number of such places should be at least equal to the number of cars, the resulting net can look too complex, unless hierarchical models are implemented, as described below.

### EXAMPLE 2

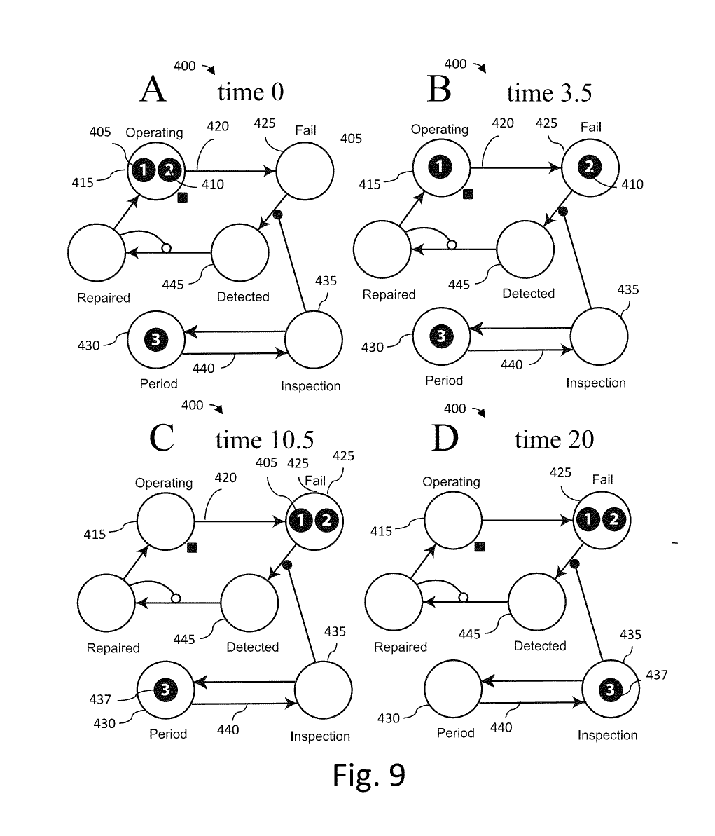

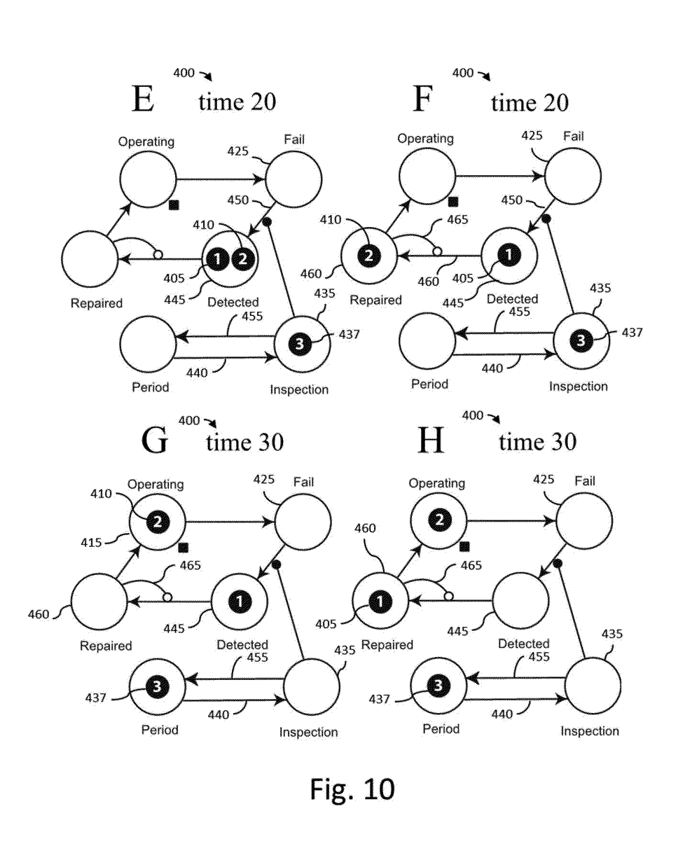

FIGS. 9 and 10 illustrate an example of system reliability modeling, where Petri Nets are used to demonstrate how a relatively simple system requires a fairly complex modeling using SPNs. As demonstrated below, the corresponding APN is significantly smaller and easier to read.

There are two redundant components with failures that are only revealed by periodic tests; failures remain undetected until the next periodic test occurs. The periodic test interval is z, and both components are tested at the same time. Once the failure of a component is detected by a periodic test, the component is repaired, provided that repair crew is available. There is only one repair crew, so both components cannot be repaired at the same time. If both components need repairs, one of them is placed in a queue where it needs to wait until the repair of the other component is completed. In this example, one of the components is assigned a higher priority, so it is selected for repair first if both components need repair at the same time; however, there is no preemption of the repair process—if the repair of the lower priority component has started, it is completed regardless of the status of the other component. Alternative queuing policies can be easily implemented as well (see the next example).

FIGS. 9, 10 show the frame-by-frame changes of the system 400 as the simulation time progresses. Frame A in FIG. 9 depicts the initial state of the model at time t=0. There are two tokens 405 (Color 1, as depicted) and 410 (Color 2) in the “Operating” place 415. The transition 420 from that place to the “Fail” place 425 is color-specific, so different failure distributions can be assigned to individual tokens that represent the components of the system 400. In the considered example, the first component denoted with Color 1 with transition properties following exponential distribution with the mean time to failure of 100 time units, while the failure of the second component (Color 2) follows Weibull distribution with the scale parameter θ=200 time units, and the shape parameter β=2. In a computer implementation of Monte Carlo simulation, different runs are distinct, accounting for the random nature of the system's behavior, and the appropriate statistical measures of system performance are aggregated over many simulation runs.

The particular run shown in FIGS. 9, 10 has been selected to demonstrate the model's behavior when both components fail within the same inspection interval (in this example, the inspection interval is chosen to be 20 time units, which is implemented by assigning a fixed 20 units delay to the transition 440 from the “Period” place 430 to the “Inspection” place 435). The first failure occurs at Time 3.5 (Frame B in FIG. 9, and so the token 410 (Color 2) moves to the “Fail” place 425 by means of the transition 420. The second failure (token 405, Color 1) occurs at Time 10.5 (Frame C), so at this point both components have failed, and those failures have not been detected. At Time 20, inspection occurs (the token 437 representing the inspection moves from the “Period” place 430 to the “Inspection” place 435 [Frame D] in FIG. 9). This enables the instantaneous transition 450 from the “Fail” place 425 to the “Detected” place 445, and both tokens 405 and 410 move from the former place to the latter place (Frame E in FIG. 10) (in order for this transition 450 to fire, its delay should be smaller than the delay for the transition 455 from the “Inspection” place to the “Period” place). Next, the token representing the component with the higher repair priority (the token 410 in this case) immediately moves to the “Repaired” place 460 (Frame F), thus preventing the other token 405 moving to the same place due to the inhibitor 465 originating at the “Repaired” place 460. There are different implementation methods for implementing priorities, the simplest being selecting a smaller fixed delay for the colors with higher priorities: for example, one can assign to the transition 470 from the “Detected” place 445 to the “Repaired” place 460 a fixed delay 1×10⁻⁶ time units for the tokens 405, and 2×10⁻⁶ for the for tokens 410 (assuming that the transitions 450 from the “Fail” to “Detected” are the same for both colors). This ensures that token 410 is always selected first. After the first unit is repaired (in this case, a fixed duration of 10 time units is used) at Time 30 the token 410 returns to the “Operating” place 415 (Frame G). The inhibitor 465 from the “Repaired” place 460 is disabled, and so token 405 moves to the “Repaired” place 460 (Frame H).

Using Monte-Carlo simulation, one can obtain the performance measures of interest. For example, based on one million runs of the system for 200 time units, one can observe that at least one unit is operating about 98.1% of the time, while both units will be operating about 73.9% percent of the time; the repair crew will be engaged about 12.7% of the time, with the expected number of started repairs being 2.12 for the simulated time; at least one unit having failure undetected 13.9% of the time; and a component waiting for repair less than one percent of the time. Here and below, the time percentage of a particular state is evaluated by taking an average over the second half of the system operation (between Times 100 and 200). If higher performance is desired, the effectiveness of various improvements can be evaluated: for example, adding a repair crew (which is implemented by changing the multiplicity of the inhibitor 465 to 2 (or, given the fact that there are only two components, simply removing the inhibitor 465 altogether), will result only in marginal improvement, by raising the chances of both units operating to 74.6% (this is expected given the low chances of a component waiting for repair). On the other hand, keeping one repair crew while making the inspection intervals twice as frequent would increase the chances of both units operating to 78.9%.

### EXAMPLE 3

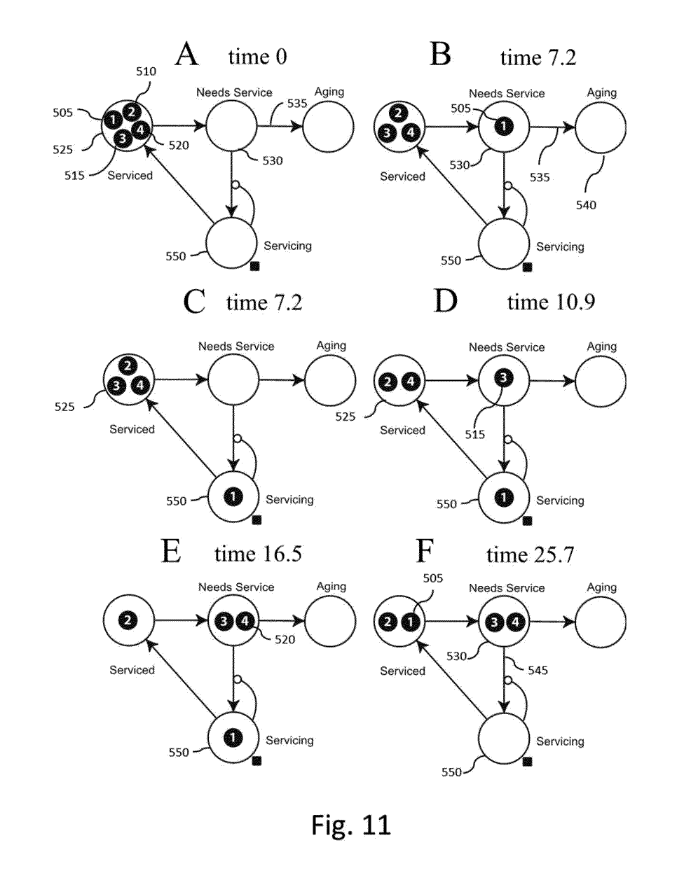

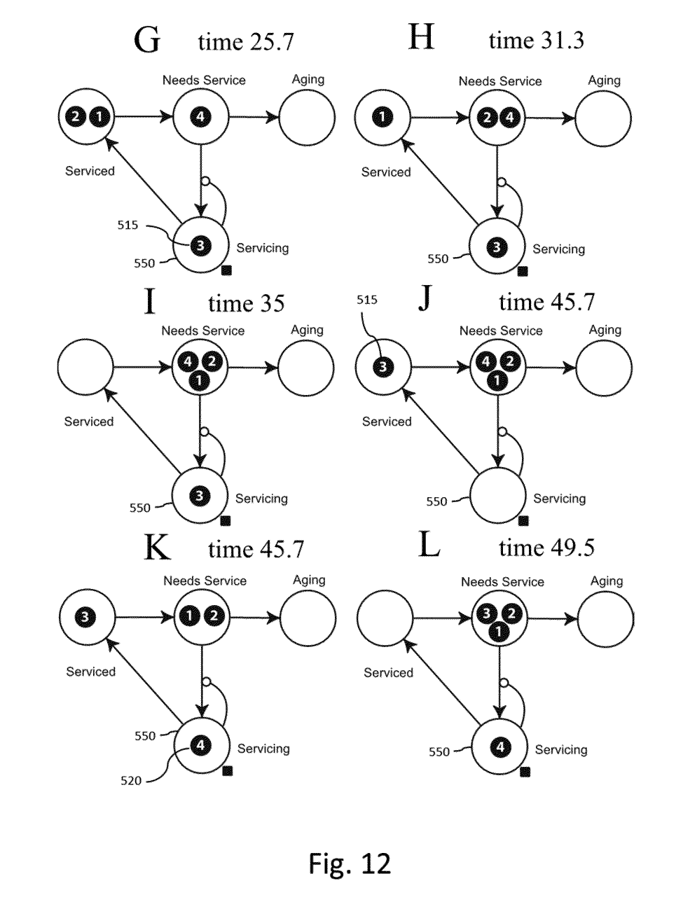

The ability to model queues is fundamentally important for a system's performance evaluation, to the point that special queuing constructs were suggested to enhance the modeling capabilities of SPNs. One of the most commonly used priority schemes, First-In-First-Out (FIFO), can be implemented using APNs (see FIGS. 11, 12). At Time t=0 (Frame A in FIG. 11), there are four tokens 505, 510, 515 and 520 in the “Serviced” place 525 representing four units, each with a distinct color (1, 2, 3 and 4) for visual identification. This is a closed queuing system, so serviced units return for service at some point in time (an open system can easily be implemented as well using tokens' sources and sinks). At some point tokens move to the “Needs Service” place 530 (see the token 505 in Frame B), in which the tokens start aging in accordance to the transition 535 to the “Aging” place 540. This transition 535 is chosen to be slow enough so that it never actually fires: instead, its sole purpose is to change the ages of tokens that are located in the “Needs Service” place 530—the longer they stay in that place, the greater the age. When the transition 545 from the “Needs Service” place 530 to the “Servicing” place 550 is enabled (Frame F in FIG. 11, since token 505 (Color 1) has completed the service and moved out from place 550), the token that arrived first, which is token 515 (Color 3 Frame D in FIG. 11), accumulates greater age, and is fired first (Frame G in in FIG. 12). Similarly, when the service of this token is completed (Frame J), the token with the greatest age (the token 520 (Color 4) in this case, that arrived at Frame E), is moved to service (Frame K). The ages of the tokens are reset when they leave the “Needs Service” place (so that the age can be used for other purposes in the model, including when the token returns to the place). It might be desirable not to reset the age, however, as it will result in the policy that takes into account previous waiting times, and services the one with the maximum accumulated waiting time. By reversing the aging process, the Last-In-First-Out (LIFO) ordering scheme can be implemented as well.

### EXAMPLE 4

The next example pertains to modeling air traffic control procedures. A portion of the East Feeder Sector for LAX airport is modeled, where only the air traffic fluxes going through the feeder points “GRAMM” and “LAADY” are taken into consideration. Each airplane is assumed to fly an Optimized Profile Descent (OPD) that minimizes the use of the aircraft's throttle and follows continuous descent profile instead of using a traditional step-wise descent. This approach is attractive from the fuel-saving and noise-profile perspectives, but it introduces uncertainty in terms of the effective ground speed of the aircraft due to wind variability. An underlying assumption for the feeder sector is that the feeder points and the merging point for the various traffic streams are positioned in such a way that airplanes flying from their respective feeder points will arrive at the merging point at the same time if moving with the same ground speed profile. Therefore, in nominal conditions, no conflict should arise if the aircraft are properly spaced within each traffic stream and the streams are properly synchronized, even though that is often not the case due to the differences in the environmental conditions and the kinematics of each aircraft.

This synchronization between the streams is implemented by ATC that checks for conflicts for every vehicle arriving at a feeder point; at that time any aircraft trailing behind, either on the same traffic stream or on another one, is issued a −20 kts or −40 kts velocity-change if its horizontal distance from its feeder point is within 5 nm or 2.5 nm, respectively. This model captures only a portion of the actual procedures that ensure the proper spacing upon merging. A simple conflict resolution logic consisting of one single maneuver being issued per conflict was investigated, with only two maneuvers able to be executed.

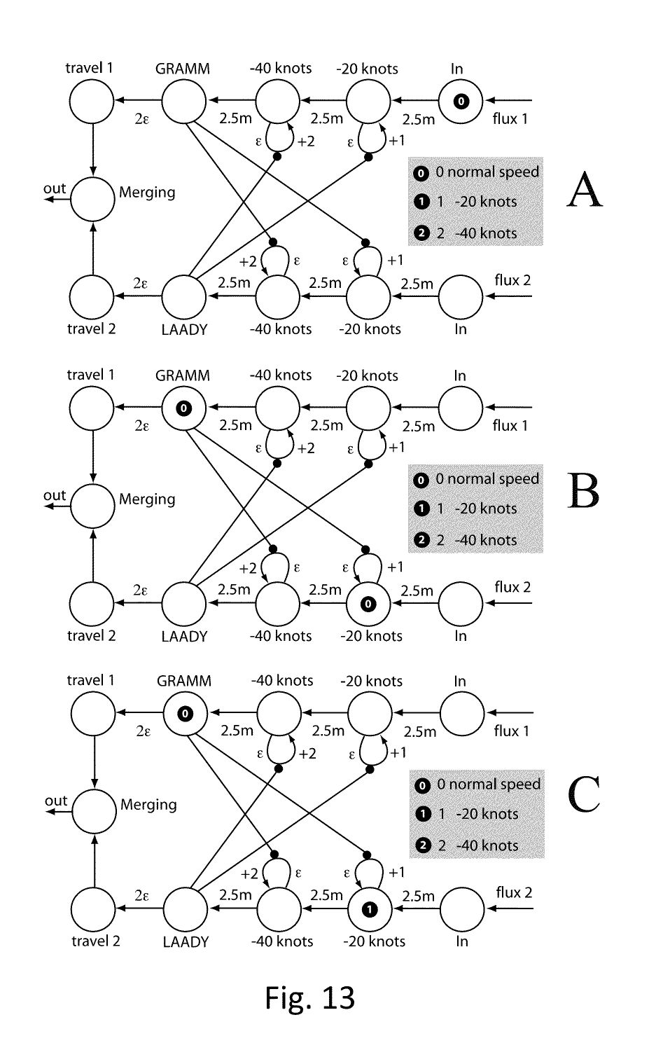

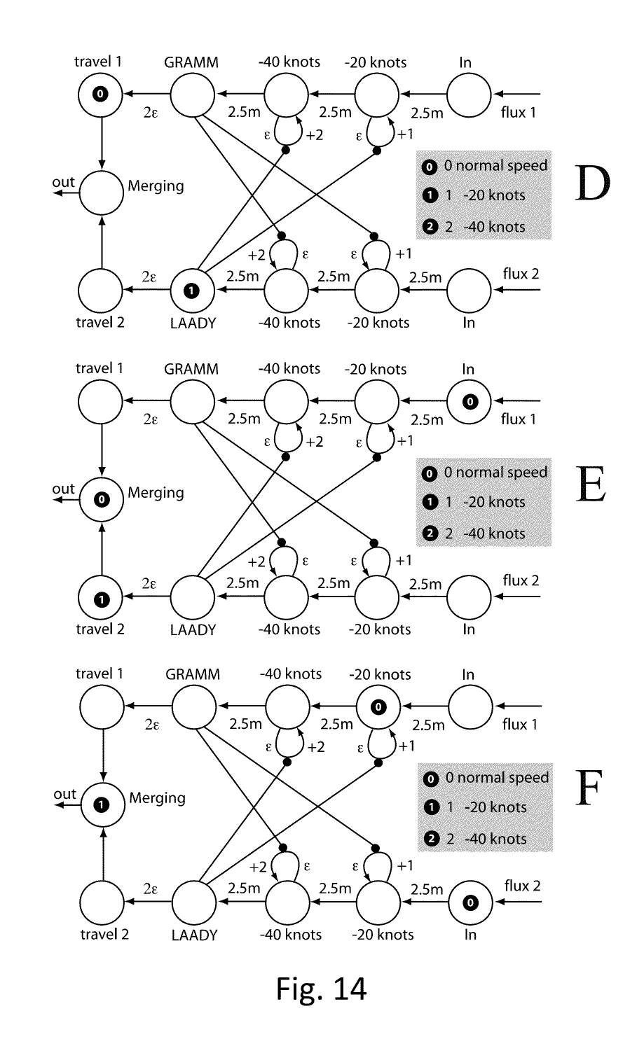

The corresponding schematics of the APN model are shown in FIGS. 13 and 14. The APN model is obtained by direct recasting of the SPN model described in [15]. Places depict the possible positions of an aircraft, while the aircraft are represented by tokens. The top of the model represents Flux 1 (moving from the right to the left) passing through the GRAMM feeder point, while the bottom corresponds to LAADY Flux 2. Each token representing an aircraft is assigned one of the three colors (“0”, “1”, “2”) based on whether ATC issues a command for this aircraft to slow down. The delays associated with the transitions “travel 1” and “travel 2” are color-dependent with the corresponding distributions provided by the agent-based simulation. In Frame A (FIG. 13), an aircraft appears in the “In” place of Flux 1.

When a token is in the GRAMM place (that is, an aircraft that has just reached the feeder point GRAMM, as depicted in FIG. 13, Frame B), two transitions are enabled for the LAADY flux by means of enablers. As a result, if there is a token in the input place for one of those transitions (FIG. 13, Frame B; this is true for the “−20 knots” place, i.e., an aircraft is located somewhere between 2.5 miles and 5 miles away from the fix LAADY), then this token is fired through the transition “+1,” which deposits the token into the same place but changes its color from “0” to “1” (FIG. 13, Frame C; note that there is a fixed small delay [symbol] associated with this transition while the token in the GRAMM place stays for 2ε ensuring that this change occurs). The color-changing transition is color-sensitive as well (the firing occurs only for the color identified a “0”). Similarly (not depicted), if there is a token in the “−40 knots” place (e.g., an aircraft is located less than 2.5 miles from the fix LAADY) then this token is fired through the transition “+2,” which deposits the token into the same place while changing its color from “0” to “2”.

The reciprocal policies are implemented for the aircraft that need to be slowed down within the GRAMM flux based on their position when another aircraft passes the LAADY feeder point. The delay associated with the “spacing” transition determines the degree of spacing violation: statistics are collected of the frequency of any two tokens located in the “Merging” place at the same time, so the longer delay of “spacing” transition corresponds to the larger spacing. Effectively, here the spacing is evaluated in the time domain, which is obtained from the space domain based on the speed profile of the vehicles. In the considered run (FIG. 14), no spacing violation takes place, as the aircraft from Flux 1 appears in the “Merging” place prior to the aircraft from Flux 2 (Frame E) and leaves that place before the latter aircraft gets there (Frame F).

### EXAMPLE 5

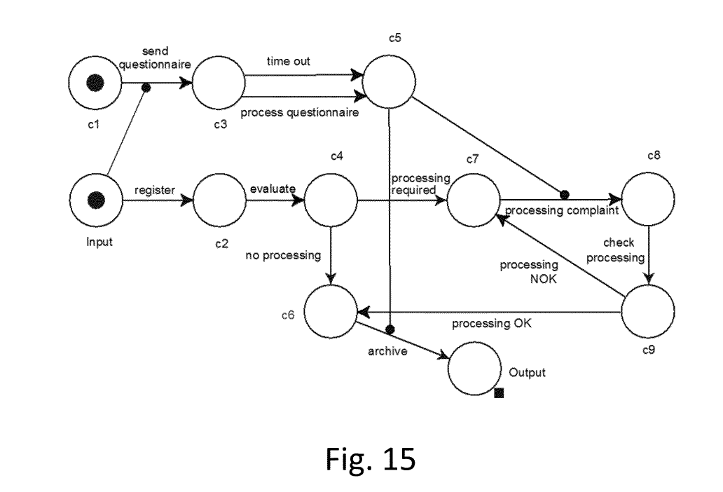

Next, consider APN model for processing of complaints. FIG. 15 depicts the APN model that directly corresponds to the equivalent SPN model (FIG. 8.). Here the names of transitions identify the associated processes and so the diagram is self-explanatory. It is suffices to note that a token must be present in the c5 place (indicating that either the questionnaire has been processed or the time allocated for the questionnaire has elapsed) in order for “processing complaint” and “archive” transitions to be enabled and the corresponding activities to commence. The enabler to the “archive” transition is not redundant in the case when no processing is needed (the transition from the c4 place to the c6 place fires.

### EXAMPLE 6

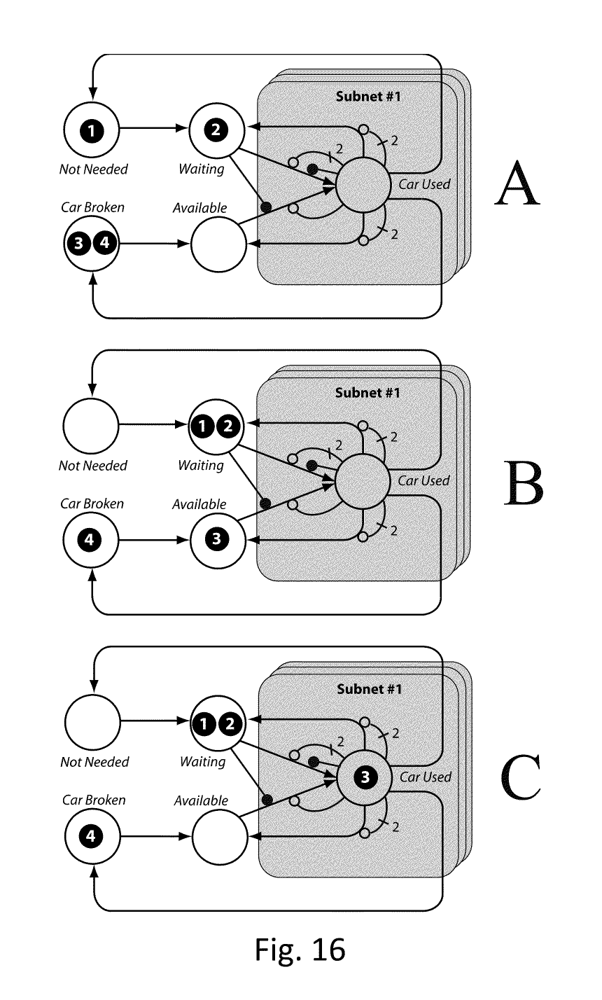

In order to match pairs of supply and demand in a compact fashion, it is convenient to expand the model into the third dimension (or “depth”) by considering subnets stacked in layers, as depicted in FIGS. 16 through 19. Unless one wants to assign specific properties to particular pairs of tokens (see the next section), the number of pairs never exceeds the number of cars, so that for k cars at most k subnets are needed.

In a software implementation, these layers can be created automatically, and one can switch the views among layers (by bringing the layer of interest to the top of the stack) as desired. The six triggers of each subnet (see the right, shaded part of FIG. 16) are arranged to match one car with one customer within each net (assuming that both customer and the car are available). Frame A (FIG. 16) depicts a situation where there is a customer waiting for a car, but no cars are available: a token (Color 2) appears in the “Waiting” place and enables an immediate firing of a token representing a car from the “Available” place to the “Car used” place, but there are not tokens in the “Available” place. At the time shown in Frame B a token (Color 3) representing a car moves to the “Available” place (the car has been repaired) Immediately, the token is moved to the “Car Used” place (Frame C) and the inhibitor from that place disables this transition, preventing more tokens (representing cars) from being fired (if there were more tokens in the “Available” place they would not move). It must be noted that the reverse transition is also enabled momentarily, so either that transition needs to be made a lower priority (e.g., slower, if fixed small delays are used), or one may make the triggers color-sensitive (so that the enabler in the transition from the “Waiting” place to the “Car Used” place is sensitive only to car tokens, while the inhibitor is only sensitive to the customer tokens—the multiplicity of the inhibitor should be equal to unity in this case).

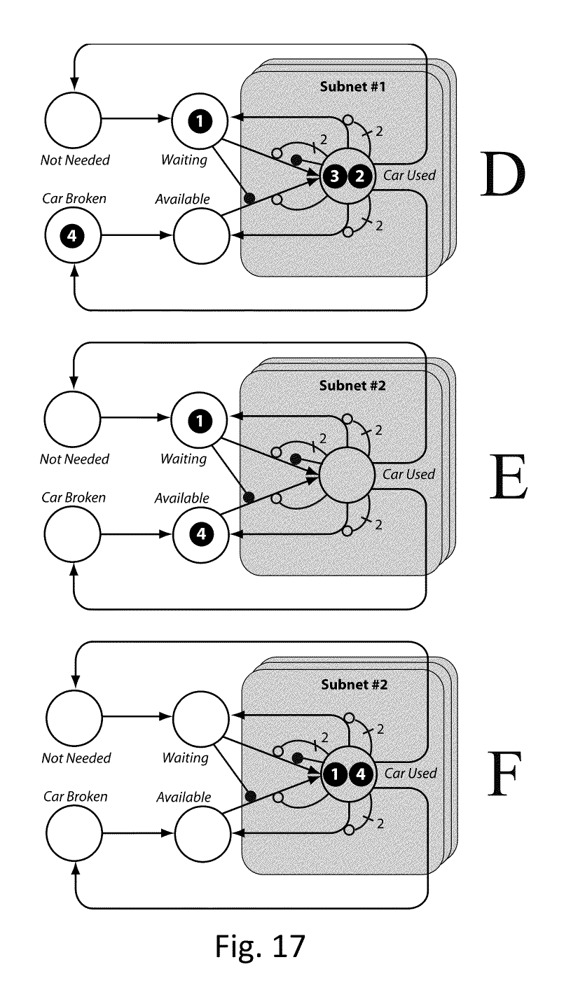

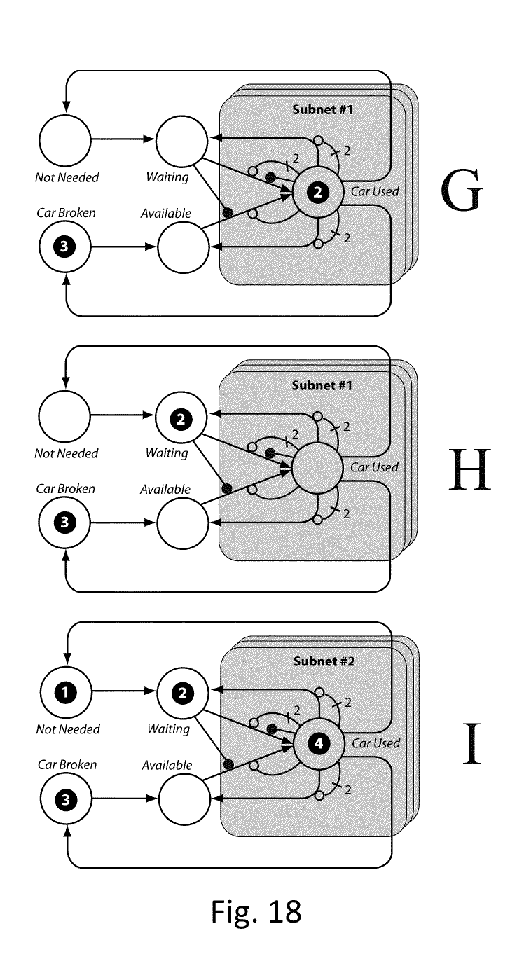

At the same time, the transition for the customer to move from the “Waiting” place to the “Car Used” gets enabled and fires a token with Color 2 (Frame D, FIG. 17), and similarly the inhibitor ensures that only one token moves (since the total number of tokens in place “Car Used” is two, that is the multiplicity of the corresponding inhibitor). As a result, the customer represented by the token with Color 1 continues to wait for a car. When the second car is repaired (token with Color 4), transitions for the subnet #2 are enabled (Frame E) and the matching of customer with the car takes place (tokens with Colors 1 and 4, Frame F). At this point both customers are driving cars. If a car breaks in the first subnet (Frame G, FIG. 18) the corresponding token with Color 3 moves to the “Car broken” place, then the transition from the “Car Used” place to the “Waiting” place becomes enabled and gets fired (token with Color 2, Frame H).

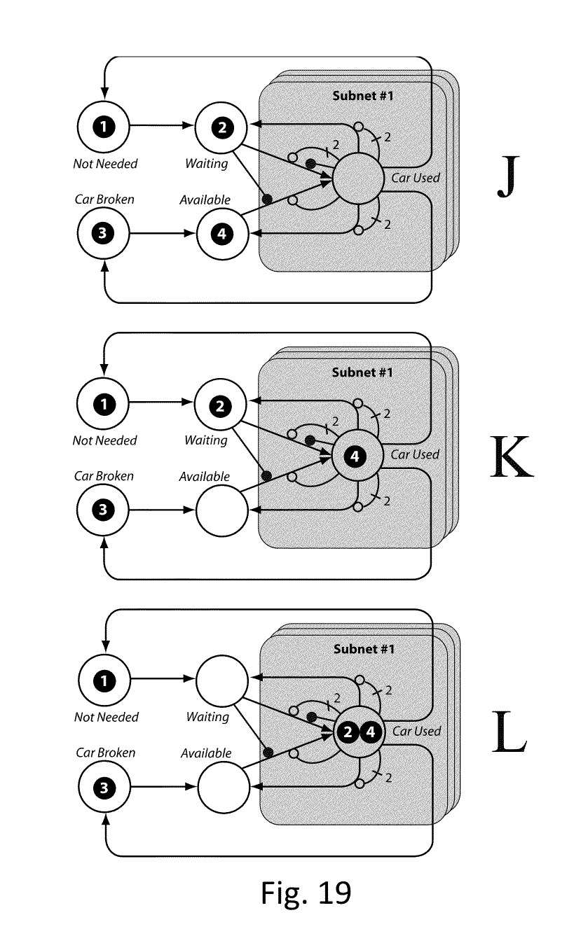

When the trip ended for the second pair (the customer's token with Color 1 moves to the “Not needed” place, Frame I), then the car's token with Color 4 moves back to the “Available” place (Frame J, FIG. 19), enabling the possibility for the first customer (Color 2) to complete the trip (Frames K and L).

In the previous example, all subnets were essentially equal—they simply provided a means of accounting for each pair of tokens separately. However, one can further refine the model and allow for the possibility of differentiating among the subnets. In the considered example, a particular combination of colors may be assigned to a specific subnet that might have distinct properties (for example, if a teenager drives a car, the chances of the car's breaking might increase). A general mechanism that facilitates the modeling of this and similar situations may then be described.

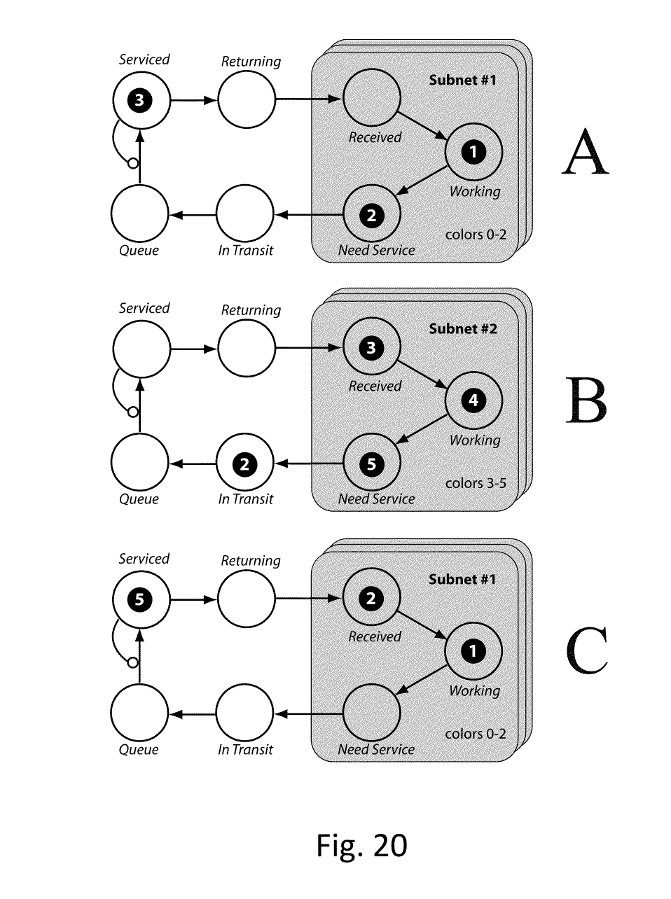

Consider a situation with multiple but distinct subnets, so that tokens that leave a subnet should be returned to that specific subnet and not to any other subnet. A repair process is one example of this situation, and so is the processing of documents: when a car is sent to the shop, one hopes to receive the same car fixed (and not somebody else's fixed car). Using an automated color shift allows this situation to be modeled automatically. The range of colors utilized in the subnet that is used as a template for multiple subnets (see FIG. 20) is determined This range is denoted as 0 . . . j−1 without the loss of generality (recall that colors are useful only to differentiate transition policies, so they can always be shifted together). If one wants to create m subnets, then one simply introduces a shifted range of colors: for k-th subnet (1≦k≦m) the corresponding range of colors will be jk . . . j(k+1)−1. An automatic check of color changes can be implemented to verify that colors are not changed outside of the subnet so that a token cannot be accepted by the “wrong” subnet. For example, in FIG. 20 the token with Color 3 returns to Subnet 2 (Frame B), while the token with Color 2 returns to Subnet 1 (Frame C, here j=3).

Applications include but are not limited to system reliability and maintenance and modeling, logistics, business processes and workflows, and system biology.

### EXAMPLE 7

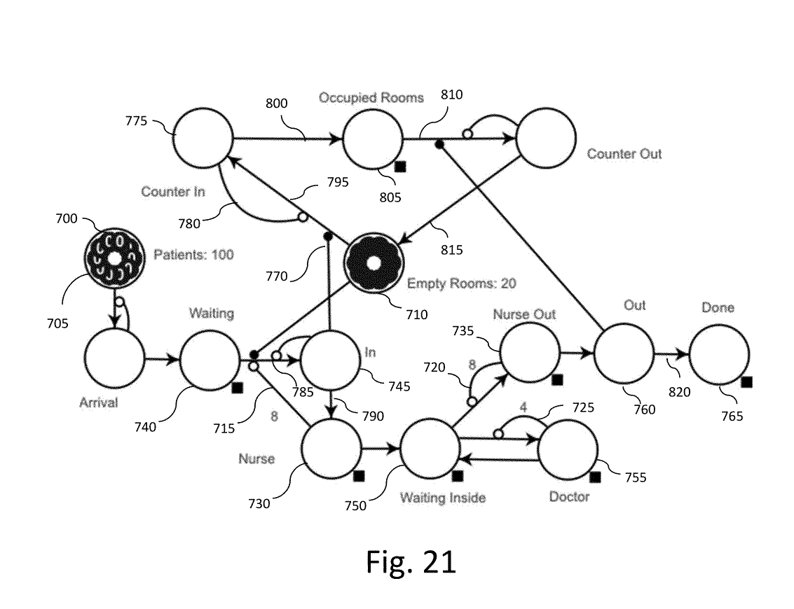

In another example, consider a model of a medical office operation shown in FIG. 21, where limited resources of doctors, nurses, and rooms must be balanced to serve the patients in the most efficient manner. Patients represented as tokens 700 are initially located in the “Patients” place 705. In this example there are 100 customers as indicated in the counter that is a part of the “Patients” place label. There are 20 rooms (the “Empty Rooms” place 710 has 20 tokens); eight nurses, as indicated by the inhibitors 715 and 720; and four doctors, as indicated by the inhibitor 725. Note that the same nurses are attending to both checking in and checking out of the patients, so the “Nurse” place 730 and “Nurse Out” place 735 are effectively the same place from the logic of the model perspective, but they are shown separately in the net for visual clarity. This is referred to as “fusing” the two places (places 730 and 735 in this case). As a result, either of the inhibitors 720 and 725 prevents entering the places 730 and 735, respectively, if the combined number of tokens in those two places is eight (which is the multiplicity of the inhibitors). The customers arrive at random intervals in accordance with a known pattern based on historic demand and appointment scheduling, and proceed to the reception room. This is modeled by moving tokens into the “Waiting” place 740. If there is a nurse and a private room is available at the facilities, nurse attends to the patient and the room becomes occupied. This is modeled by moving the patient's token first to the “In” place 745 (see [0004] for the details), and then to the “Nurse” place 730. After nurse completed the check in, the patient remains in the room and waits for the doctor (the corresponding token moves to the “Waiting Inside” place 750). When the doctor is available, patient's token is moved to the “Doctor” place 755. When the doctor is done with the patient, the patient's token changes its color from zero to one and is moved back to the “Waiting Inside” place 750. When a nurse is available the patient token is moved to the “Nurse Out” place 735; when the Nurse completes the check-out procedure, the patient's token is moved to the place “Out” 760 and, finally, to the place “Done” 765.

The upper portion of the net shown in FIG. 21 provides a mechanism for counting the number of occupied rooms: when a patient's token appears in the “In” place 745 it engages the enabler 770, thus allowing one token from the “Empty Rooms” place 710 to move to the “Counter In” place 775. Once this happens, the inhibitor 780 engages, ensuring that only one token can be located in the “Counter In” place 775. The delays of the involved transitions are times in such a way that one token passing through the “In” place 745 causes exactly one token moving out from the “Empty Rooms” place 710. Specifically, if we denote a small fixed delay as c (in this example, ε=0.000001 of an hour is used) assigned to transition 785, then transition 790 is assigned delay 3ε, while transitions 795 and 800 are assigned delays 2ε each. Let us consider that at a time T there is a customer in the waiting room and both a nurse and a room are available. At time T+ε transition 785 fires (moves) a token from the “Waiting” place 740 into the “In” place 745. This triggers transition 795 that moves a token from the “Empty Rooms” place 710 to the “Counter In” place 775 at time T+3ε. At the time T+4ε transition 790 fires (moves) a token from the “In” place 745 to the “Nurse” place 730, finally at the time T+5ε transition 800 fires and moves a token into the “Occupied Rooms” place 805. Similar configuration is used to model the release of a room when patient is served. Specifically, transitions 810 and 815 are assigned delays 2ε each, while transition 820 is assigned delay 3ε. This ensures that when one token is moved from the “Nurse Out” place 735 exactly one token is moved from the “Occupied Rooms” place 805.

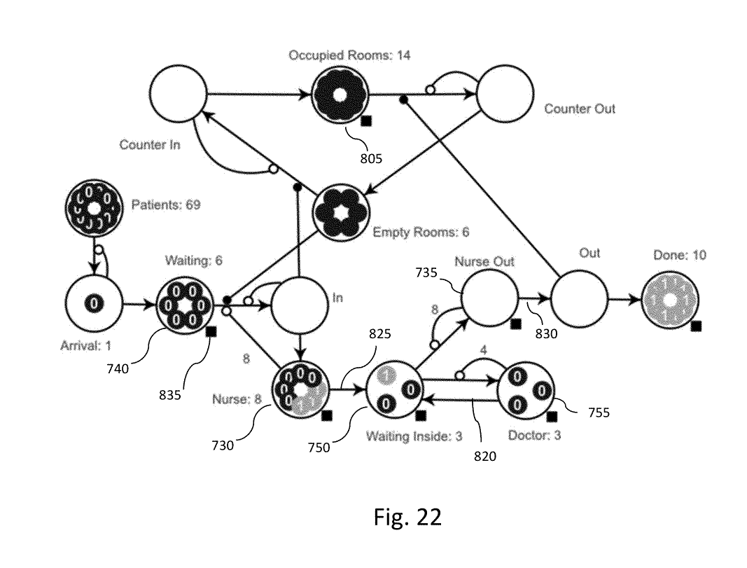

FIG. 22 shows a snapshot of the model when the simulation is in progress. At this point of simulation, there are six patients waiting in the reception, “Waiting” place 740 and three patients are seen by doctors, so there are three tokens in the “Doctor” place 755. There are three patients waiting inside (the “Waiting Inside” place has three tokens). When a doctor is done with a patient and transition 820 is fired, the color of the token that represents the patient is changed from 0 to 1 (this behavior is controlled by specifying an appropriate attribute of transition 820). As a result, out of the eight patients served by the nurses (see the tokens in the “Nurse” place 730) five are in the process of checking in (tokens with color 0) and three are in the process of checking out (color 1). Recalling that places 730 and 735 are fused (that is they are distinct graphically but are the same from the logical perspective), we note that their two outgoing transitions 825 and 830 are assigned color-depended properties that ensure that tokens are flowing, as the logic of the problem requires. Specifically, transition 825 only able to transmit tokens with color 0 (i.e., for tokens that represent the patients that have not seen the doctor yet), while transition 830 only transmits tokens of color 1. The total number of occupied rooms is 14 (see the “Occupied Rooms” place 805).

Sensors 835 (see FIG. 22) allow to evaluate the relevant performance measures of the system, such as expected (mean) waiting time for the customers, or the probability of customers not served, or the number of served customers, etc. This enables the designers of the system to change its parameters and achieve an improved performance. For example, when the time of customer arrivals in uniformly distributed in the interval from 0 to 4 minutes, both check in and the check out by the nurse takes fixed 10 minutes and the duration of a doctor interaction with a patient varies in accordance with an exponential distribution with the mean of 10 minutes, the results of 1 million Monte Carlo simulation show that on average each customer will be waiting 33.4 minutes when the system is configured as described above. However, there is a possibility of using a slightly smaller facility that only has 18 private rooms instead of 20, and the resulting savings could be used to increase the number of available nurses from 8 to 9. We note that on average each patient requires exactly twice as much time with a nurse as with the doctor, so increasing the nurse to doctor ratio above two is not obviously beneficial as the number of doctors remains a bottleneck of the process. The new configuration (the same four doctors, nine nurses and 18 rooms) results in 29.3 minutes of a mean waiting time for each patient, resulting in a saving of a little more than four minutes per patient. More sophisticated measures, such as better scheduling, and further optimization of the resources can lead to further improvements. While existing methods of modeling similar systems that rely on discrete-event simulation can produce similar results, the modeling is very time consuming, and as a result, is prohibitively expensive in many applications. In contrast, the new method provides a fast, visual, and interactive means for capturing the salient features of a real-world system and expedient exploration of the ways of improving the system performance.

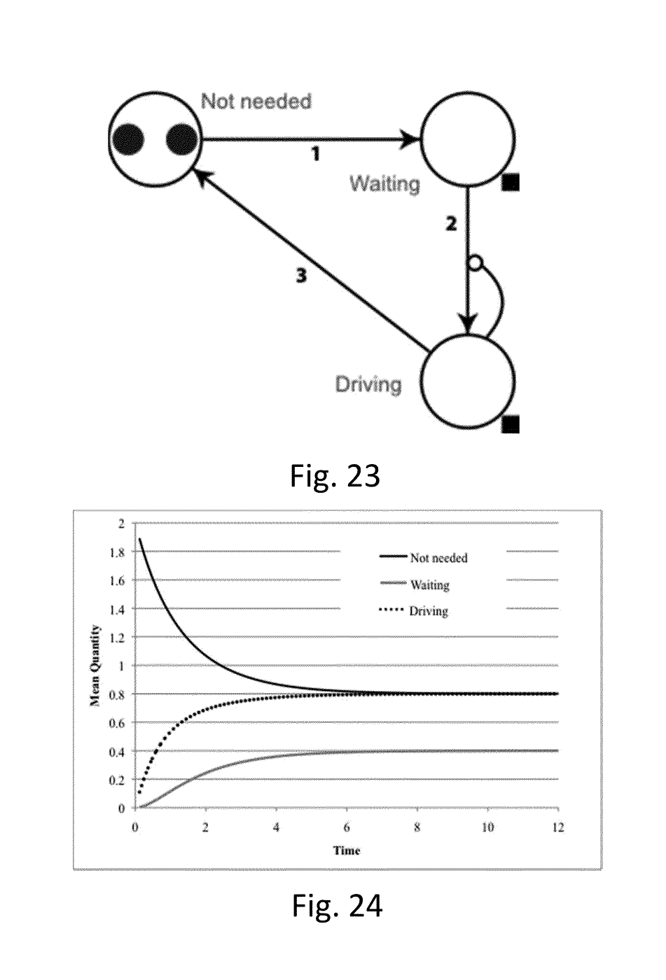

RESULTS OF SIMULATIONS. Illustrated in FIG. 23 is an APN diagram of an example a family of two that share a car. Each family member is denoted by a token and can be in three possible states (denoted with places): the car is not needed “Not needed”, waiting for the car “Waiting”, and driving the car “Driving”. In this model there is no token representing a car, instead an inhibitor is used (of multiplicity one) to prevent more than two tokens appear in the “Driving” place. This inhibitor effectively stipulates that only one car can be driven at a time.

There are three transitions in the model, numbered as shown in FIG. 23. Finally, we can assign sensors to places of interest to collect statistics about the number of tokens (so-called marking) in that place. The statistics can be related to the expected number of tokens, probability that the number of tokens crosses a given threshold or the number of times the number of tokens in a given place crosses a certain threshold (possible for a specified period of time). The presence of sensor is denoted with a solid rectangle next to a place and multiple sensors can be assigned to the same place.

In a case where the duration of simulation is T=12 hours, and where each family member does not need the car for two hours, and then would like to take a two-hour trip. Transitions 1 and 3 can be assigned fixed duration of two hours, and make transition 2 immediate (in the simplest implementation a small fixed value e may be assigned to this transition; in the considered example e=1×10⁻⁶ hours). The result is a fully deterministic model (if no distinction is made between the family members and therefore there is no need to know which of the family members gets the car first). Family members will be driving the car in turns, never waiting for the car (except during the first two hours) and ensuring that the car is effectively driven all the time (the car's utilization is 100%).

If randomness is introduced into the model and both transitions 1 and 3 are assigned exponential delays that on average result in two hour delay, then the cumulative distribution function (CDF) has the following form

F(t)=1−e^{-λt},

where λ=0.5 per hour. The resulting APN model is equivalent to a simple Markov chain, with a steady-state solution indicating that utilization of the car is 80%, and a family member would have to wait for a car 40% of the time (or 20% per family member. FIG. 24 shows the results using simulation.

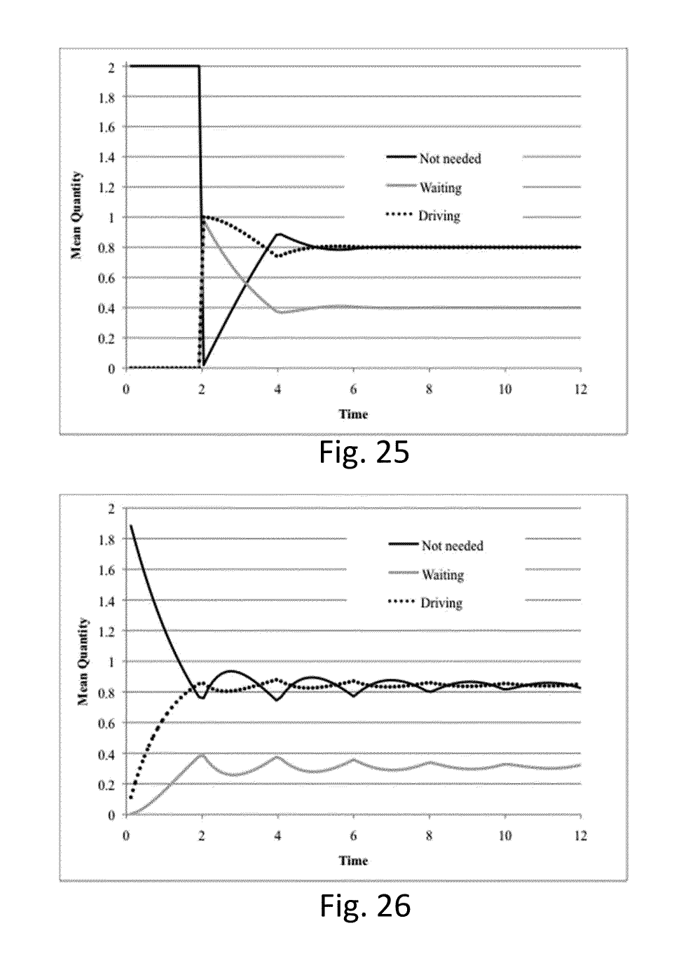

In a “mixed” situation when demand delay (transition 1 in FIG. 23) is fixed, while the trip duration is exponential (while keeping the mean values of both at two hours). A 10 min Monte Carlo replication may be used. The results show that while the transient part of the results is distinct, the steady state values are the same as in Markovian case. See FIG. 25

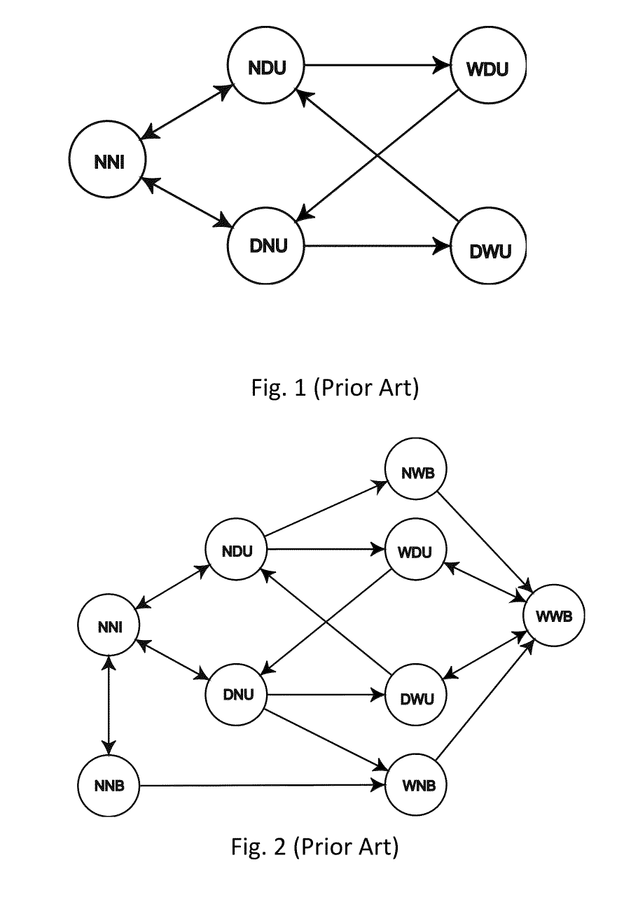

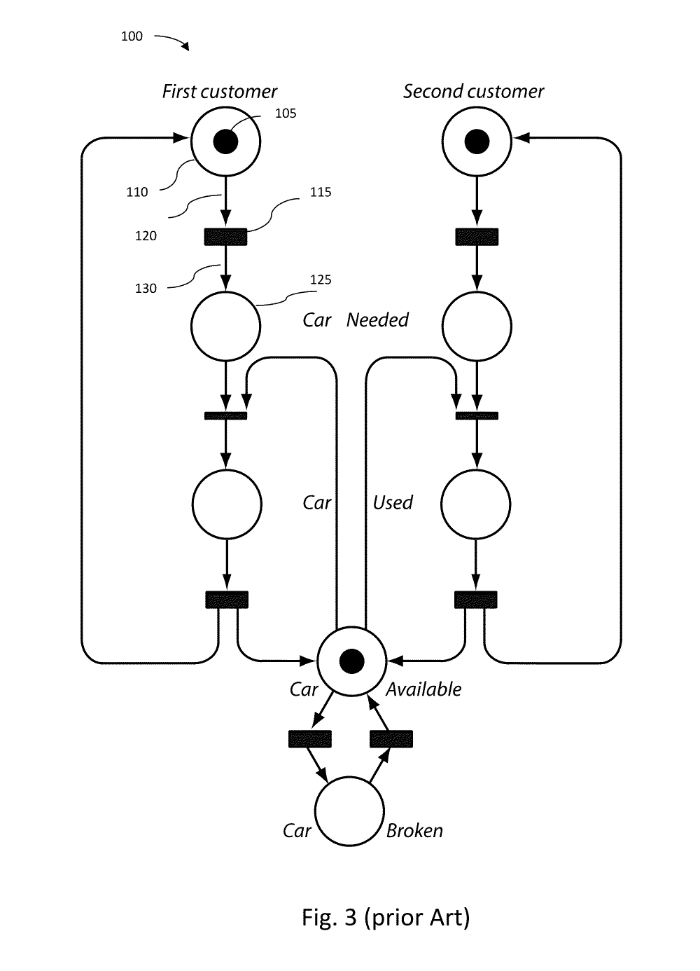

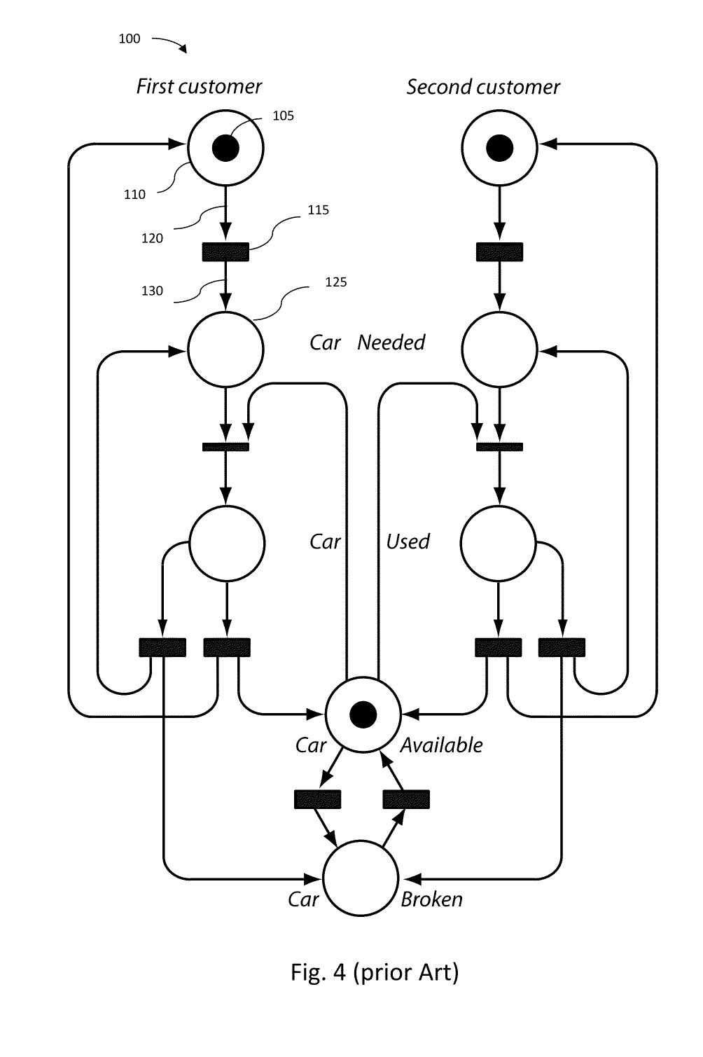

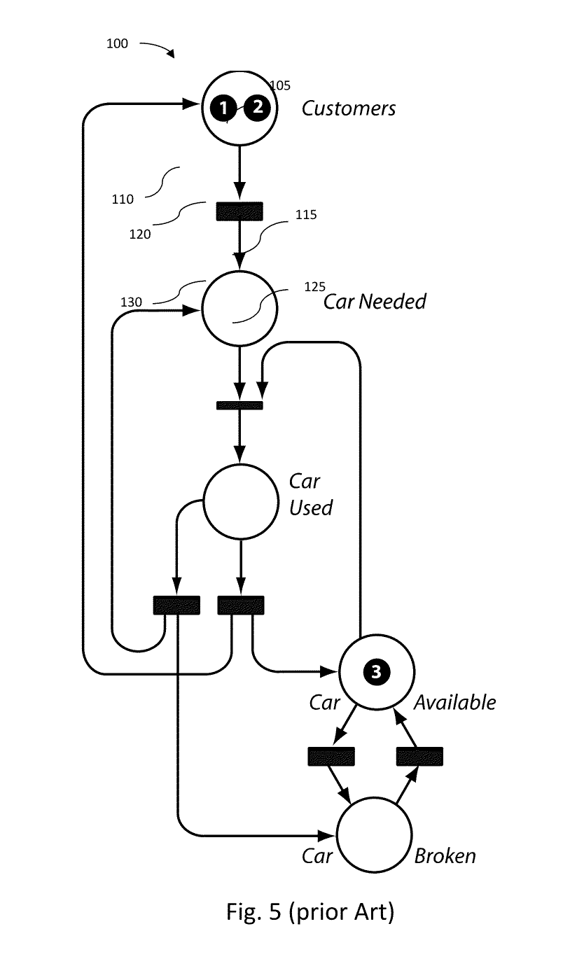

However, if the choice of distributions is reversed and an exponential distribution is used for the demand (transition 1 in FIG. 23) and fixed trip duration (transition 3 in FIG. 1), the results change, as shown in FIG. 26.

The results show that the expected values are oscillating with the amplitudes decaying relatively slowly. Second, the converged values appear to be different from those observed in the previous two cases. Running the simulation for a longer period of time, as shown in FIG. 26 confirms this observation. The converged values are 84.5% for utilization and 31% for waiting.

In another example, the same problem of a family car, but this time there is allowance for the possibility that there are times when the car can periodically break. While breaks in reality occur relatively rarely (and it takes days to fix), for illustrative purposes one can consider a situation where there are more frequent breaks that are also fixed relatively fast. If a trip is interrupted by a break, the family member has to wait until the car is fixed, and then attempt the interrupted trip again (from the beginning).

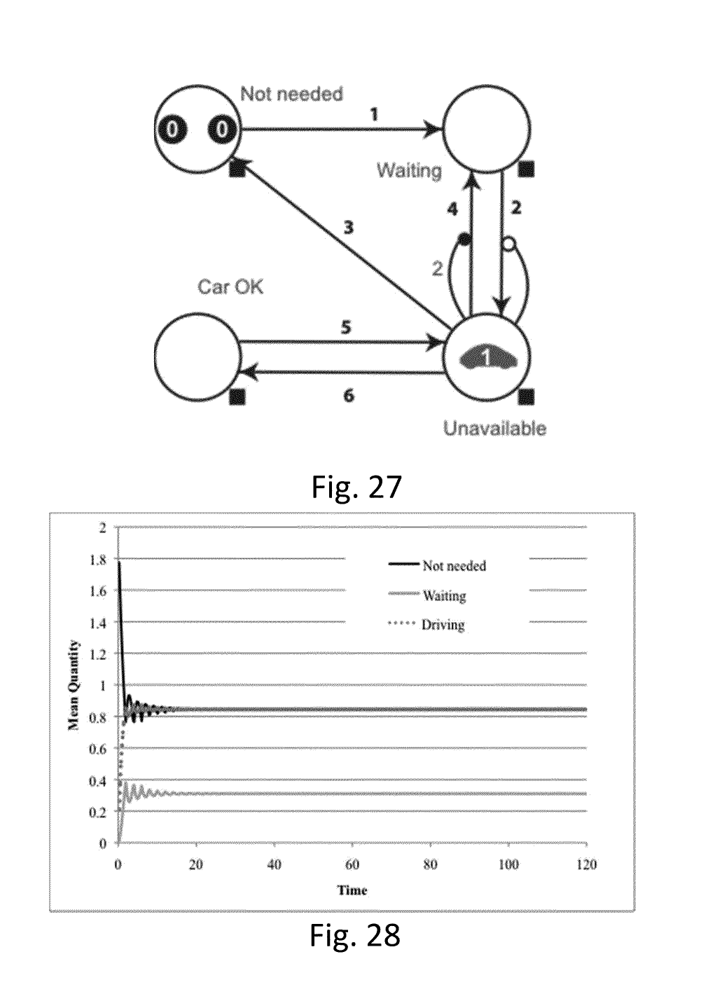

To model this situation a car token is introduced, as well as the possibility of the car breaking. Instead of creating two separate places for the two possible states of the car (broken or not), token colors (i.e., integer labels) are employed to create a more compact model as depicted in FIG. 27. In this example, a family member (customer) might not be able to drive a car (car is unavailable) for two distinct reasons—either when another family member already drives the car, or when the car is broken. The two possibilities are combined into a single place “Unavailable”, and an immediate transition 4 that “pushes” a token representing a family member to the “Waiting” place when the car breaks is introduced (due to the enabler of multiplicity 2). To make sure that tokens representing cars and people are not mixed up, they are differentiated by color: when the car token gets to the “Unavailable” place, it has color 1 as opposed to the people tokens that have color 0, and outgoing transitions from that place are color-dependent (transitions 2 and 3 are only sensitive to color 0 (people), while transition 6 only to color 1 (car).

Assume a case where the car breaks in accordance with an exponential distribution with the rate 0.2 per hour, and it is restored after fixed delay of 0.2 hours. This implies that the car is available 96.15% of the time. The results of this scenario are shown in FIG. 28 and the car availability corresponds to the “Car OK” curve. First, we note that introduction of the possibility of car breaking provides damping (or mixing) to the model, so that convergence to the steady-state occurs faster. Second, while car utilization (the amount of driving) actually goes up by about 1.5% to about 86%) the amount of waiting significantly increases from 31% to 44.4% (or 22.2% per family member or customer). One of the reasons for such significant increase is the fact that interrupted trips start from scratch. However, even more remarkable is the importance of “mixing” that eliminates effects of coordination, so that now whether we had fixed trip duration or equivalent exponential delay does not make any difference (in other words, for Markov model waiting increases from 40% to 44.4% due to the presence of breaks.

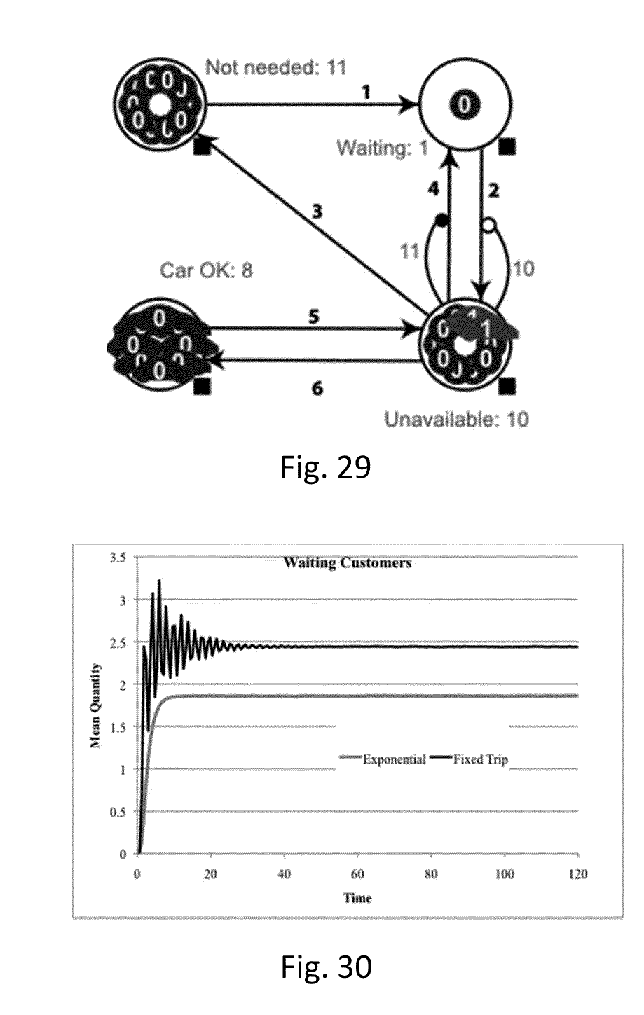

The effects of pooling the resources can also be considered. The model is set up for easy scalability: there is a need to add more tokens and adjust the trigger multiplicity. A fleet of k=10 cars with 20 customers. The model is shown in FIG. 29—where the multiplicity of the enabler now is k+1=11 and the multiplicity of the inhibitor is k=10. At the time of the snapshot there are two cars broken, eight cars driven, 11 customers not needing a car and one customer waiting for a car. In this model if a car breaks, but there is another car available the customer simply hops to another available car.

The benefits of pooling the resources can be easily observed by running Monte Carlo simulation and evaluating the amount of time the customers waiting for a car (FIG. 30)—for fixed trip duration the percentage of time waiting for is almost halved (from 22.2% to 12.2% per customer). Increasing the number of customers decreases the damping in the system and a noticeable oscillations are observed for some time. Furthermore, comparing exponential and fixed trip durations lead to a reverse trend as compared to what we observed for a single car problem: using exponential durations for trips instead of fixed ones leads to a decrease in waiting to 9.3% per customer.

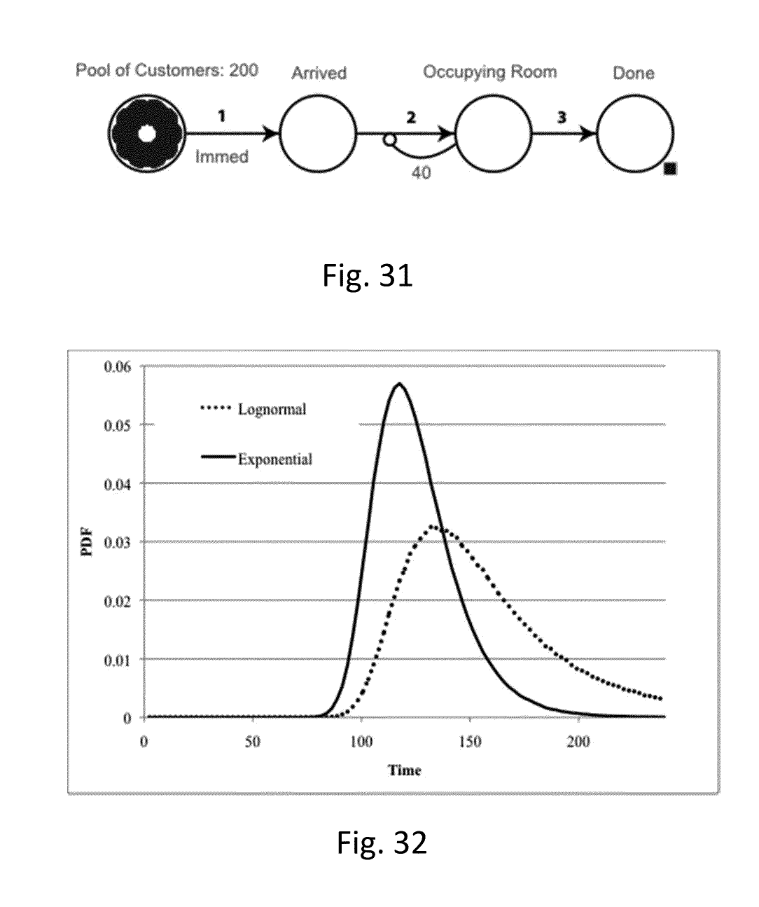

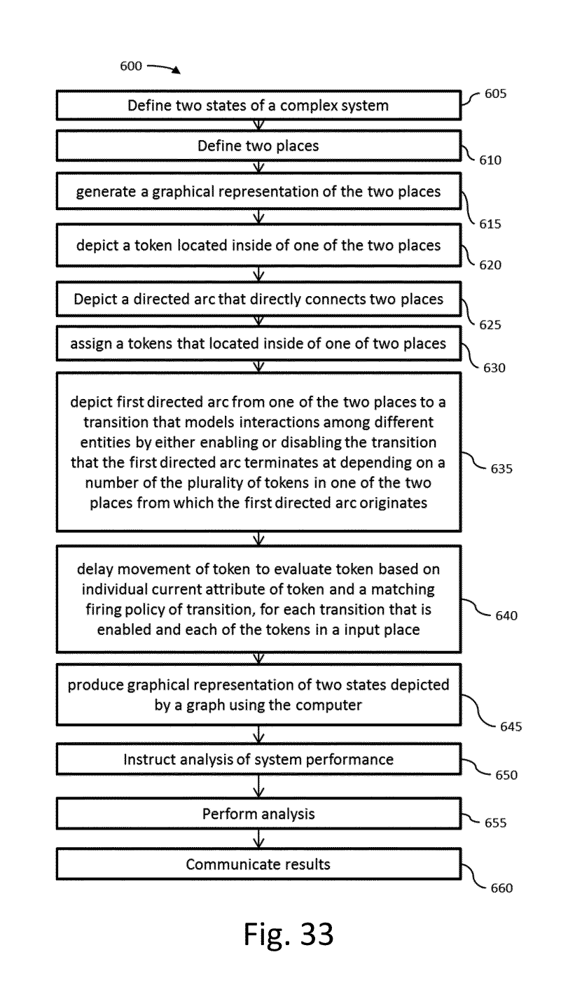

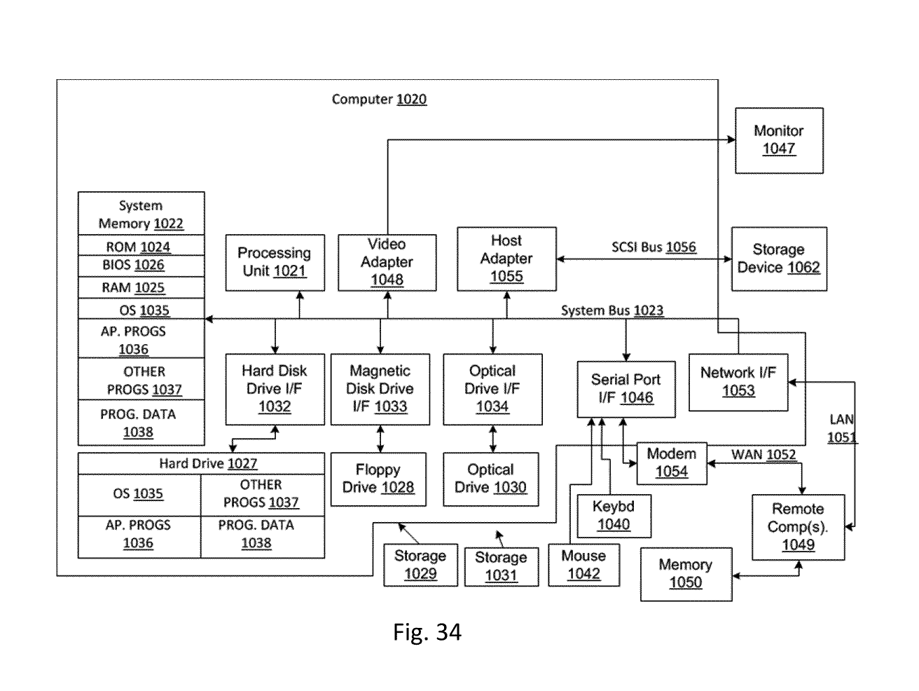

In another example, a visit to clinic is modeled. One may consider a simple problem of finding whether the number of rooms is sufficient to accommodate the customers. One may start with the conservative assumption that all customers arrive at 9 am, and try to figure out the chances that all customers will be served by noon. The model is shown in FIG. 31, here the first two transitions are immediate (the arrival of the customers is controlled by transition 1 and transition 2 correspond to the transition from the waiting room into a patient room. Finally, transition 3 has a delay associated with the length of stay in a room for an individual customer. Consider a simulation for four hours (240 minutes), with the mean value of 15 minutes and 40 rooms. The total number of customers is 200. 1 million simulations are run first using exponential distribution and then with log normal distribution that has the same first two moments (mean and variance). The comparison of the obtained PDFs is shown in FIG. 32.

The “fat tail” effect is clearly observed. In fact, if an exponential distribution is used, the chances of completing the task is 98.6%, in contrast if a log-normal distribution (with matching first two moments) is used the chances are only 77.1%.

Illustrated in FIG. 23 is a method 600 for modeling nondeterministic time-dependent behavior of a complex system that is comprised of multiple entities. The method is implemented by a computer.

In step 605, the method 600 defines at least two states of the complex system.

In step 610, the method 600 defines at least two places.

In step 615, the method 600 generates a graphical representation of the at least two places that describe possible states of the multiple entities that comprise the complex system.

In step 620, the method 600 depicts a token that is located inside of one of the at least two places thereby denoting a current realization of one of the at least two places for an entity represented by the token.

In step 625, the method 600 depicts a first directed arc that directly connects two of the at least two places and facilitates possible movements of tokens in a direction of the first directed arc.

In step 630, the method 600 assigns a plurality of tokens that are located inside of one of the two places.

In step 635, the method 600 depicts the first directed arc from one of the two places to a transition that models interactions among different entities by either enabling or disabling the transition that the first directed arc terminates at depending on a number of the plurality of tokens in one of the two places from which the first directed arc originates.

In step 640, the method 600 delays the movement of a specific token to evaluate the specific token based on an individual current attribute of the specific token and a matching firing policy of the transition, for each transition that is enabled and each of the tokens in an input place.

In step 645, the method 600 produces a graphical representation of the at least two states of the complex system depicted by at least one graph using the computer. The method may be implemented in a computer and used to generate an instruction to perform a physical act such as for example initiation of repairs, the staggering of flights, the servicing of a customer in a queue. The method may include the performance of that physical act.

In step 650, the method 600 instructs an analysis of the system performance.

In step 655, the method 600 performs an analysis of the system performance.

In step 660, the method 600 communicates the results of the analysis of the system performance.

The method may also include the steps of depicting the first directed arc from one of the at least two places to a transition that provides a mechanism for modeling interactions among different entities by either enabling or disabling the transition that the first directed arc terminates at depending on a number of the plurality of tokens in one of the at least two places the first directed arc originates from.

The step of producing a graphical representation may include for each transition that is enabled and each of the plurality of tokens in an input place, delaying movement of a specific token to evaluate the specific token based on an individual current attribute of the specific token and a matching firing policy of the transition.

The step of delaying movement may be deterministic and may be evaluated independently of a presence or absence of tokens other than the specific token in one of the at least two places.

In the method, the token may have attributes that include discrete labels and continuous labels.

In the method a collection of subnets containing at least one selected from among a group consisting of places, tokens, transitions, and triggers that is arranged in layers in an order that is predetermined may be included. The layers may be multiplied, with consequent specific changes applied to each one of the layers if needed. The order may be changed in a computer implementation. A color shift may separate valid color ranges into disjoint sets for each of the layers. The tokens that leave one of the layers and move to another location on a net can return to a specified location of the layers.

The method 600 may be implemented as a step in a method for managing the behavior of a complex system having multiple entities. The method for managing the behavior of a complex system having multiple entities may include performing a performance analysis of the model and generating software source code that simulates the model. A compiled file may be obtained by compiling the software source code, and thereafter transforming at least one of the multiple entities of the complex system responsive to execution of the compiled file.

The method 600 may be implemented as a step in a method for managing a complex system where the complex system is changed based on the performance analysis of the complex system. The method 600 may be used in a method for displaying a graphical representation of a complex system by displaying the graphical representation generated on a computer screen.

The method 600 may be implemented as a step in a method for determining the performance of a nondeterministic, time-dependent behavior of a complex system is comprised of multiple entities.

FIG. 24 is a block diagram representing a general purpose computer system in which aspects of the methods and systems disclosed herein and/or portions thereof may be incorporated. As shown, the exemplary general purpose computing system includes a computer 1020 or the like, including a processing unit 1021, a system memory 1022, and a system bus 1023 that couples various system components including the system memory to the processing unit 1021. The system bus 1023 may be any of several types of bus structures including a memory bus or memory controller, a peripheral bus, and a local bus using any of a variety of bus architectures. The system memory includes read-only memory (ROM) 1024 and random access memory (RAM) 1025. A basic input/output system 1026 (BIOS), containing the basic routines that help to transfer information between elements within the computer 1020, such as during start-up, is stored in ROM 1024.

The computer 1020 may further include a hard disk drive 1027 for reading from and writing to a hard disk (not shown), a magnetic disk drive 1028 for reading from or writing to a removable magnetic disk 1029, and an optical disk drive 1030 for reading from or writing to a removable optical disk 1031 such as a CD-ROM or other optical media. The hard disk drive 1027, magnetic disk drive 1028, and optical disk drive 1030 are connected to the system bus 1023 by a hard disk drive interface 1032, a magnetic disk drive interface 1033, and an optical drive interface 1034, respectively. The drives and their associated computer-readable media provide non-volatile storage of computer readable instructions, data structures, program modules and other data for the computer 1020. As described herein, computer-readable media is an article of manufacture and thus not a transient signal.

Although the exemplary environment described herein employs a hard disk, a removable magnetic disk 1029, and a removable optical disk 1031, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on the hard disk, removable magnetic disk 1029, removable optical disk 1031, ROM 1024 or RAM 1025, including an operating system 1035, one or more application programs 1036, other program modules 1037 and program data 1038. A user may enter commands and information into the computer 1020 through input devices such as a keyboard 1040 and pointing device 1042. Other input devices (not shown) may include a microphone, joystick, game pad, satellite disk, scanner, or the like. These and other input devices are often connected to the processing unit 1021 through a serial port interface 1046 that is coupled to the system bus 1023, but may be connected by other interfaces, such as a parallel port, game port, or universal serial bus (USB). A monitor 1047 or other type of display device is also connected to the system bus 1023 via an interface, such as a video adapter 1048. In addition to the monitor 1047, a computer may include other peripheral output devices (not shown), such as speakers and printers. The exemplary system of FIG. 21 also includes a host adapter 1055, a Small Computer System Interface (SCSI) bus 1056, and an external storage device 1062 connected to the SCSI bus 1056.

The computer 1020 may operate in a networked environment using logical connections to one or more remote computers, such as a remote computer 1049. The remote computer 1049 may be a personal computer, a server, a router, a network PC, a peer device or other common network node, and may include many or all of the elements described above relative to the computer 1020, although only a memory storage device 1050 has been illustrated in FIG. 21. The logical connections depicted in FIG. 21 include a local area network (LAN) 1051 and a wide area network (WAN) 1052. Such networking environments are commonplace in offices, enterprise-wide computer networks, intranets, and the Internet.

When used in a LAN networking environment, the computer 1020 is connected to the LAN 1051 through a network interface or adapter 1053. When used in a WAN networking environment, the computer 1020 may include a modem 1054 or other means for establishing communication over the wide area network 1052, such as the Internet. The modem 1054, which may be internal or external, is connected to the system bus 1023 via the serial port interface 1046. In a networked environment, program modules depicted relative to the computer 1020, or portions thereof, may be stored in the remote memory storage device. It will be appreciated that the network connections shown are exemplary and other means of establishing a communication link between the computers may be used.

The terminology used herein is for the purpose of describing particular embodiments only and is not intended to be limiting of the invention. Where the definition of terms departs from the commonly used meaning of the term, applicant intends to utilize the definitions provided herein, unless specifically indicated. The singular forms “a”, “an” and “the” are intended to include the plural forms as well, unless the context clearly indicates otherwise. It will be understood that, although the terms first, second, etc. may be used to describe various elements, these elements should not be limited by these terms. These terms are only used to distinguish one element from another. The term “and/or” includes any, and all, combinations of one or more of the associated listed items. The phrases “coupled to” and “coupled with” contemplates direct or indirect coupling.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements.

What is claimed:

1. A method for modeling nondeterministic time-dependent behavior of a complex system that is comprised of multiple entities, the method implemented by a computer, the method comprising:
defining at least two states of the complex system;
producing a graphical representation of the at least two states of the complex system depicted by at least one graph using the computer; wherein producing a graphical representation comprises:
defining at least two places;
generating a graphical representation of the at least two places that describe possible states of the multiple entities that comprise the complex system;
depicting a token that is located inside of one of the at least two places thereby denoting a current realization of one of the at least two places for an entity represented by the token; and
depicting a first directed arc that directly connects two of the at least two places and facilitates possible movements of tokens in a direction of the first directed arc; and
performing a performance analysis of the complex system.

2. The method of claim 1 wherein producing a graphical representation further comprises
assigning a plurality of tokens that are located inside of one of the at least two places; and
depicting the first directed arc from one of the at least two places to a transition that provides a mechanism for modeling interactions among different entities by either enabling or disabling the transition that the first directed arc terminates at depending on a number of the plurality of tokens in one of the at least two places the first directed arc originates from.

3. The method of claim 2 wherein producing a graphical representation further comprises for each transition that is enabled and each of the plurality of tokens in an input place, delaying movement of a specific token to evaluate the specific token based on an individual current attribute of the specific token and a matching firing policy of the transition.

4. The method of claim 3 wherein delaying movement is deterministic and is evaluated independently of a presence or absence of tokens other than the specific token in one of the at least two places.

5. The method of claim 3 wherein delaying movement is non-deterministic and is evaluated independently of a presence or absence of tokens other than the specific token in one of the at least two places.

6. The method of claim 1 wherein the token has attributes that include discrete labels and continuous labels.

7. The method of claim 1 further comprising a collection of subnets containing at least one selected from among a group consisting of places, tokens, transitions, and triggers that is arranged in layers in an order that is predetermined

8. The method of claim 7 wherein the layers are multiplied, with consequent specific changes applied to each one of the layers if needed.

9. The method of claim 7 wherein the order is changed in a computer implementation.

10. The method of claim 7 wherein a color shift separates valid color ranges into disjoint sets for each of the layers.

11. The method of claim 10 wherein the tokens that leave one of the layers and move to another location on a net can return to a specified location of the layers.

12. The method of claim 1 further comprising displaying the graphical representation on a computer screen.

13. A system for modeling nondeterministic time-dependent behavior of complex systems that are comprised of multiple entities, the method implemented by a computer, the system comprising:
a computer; and
a graphical representation subsystem that produces, by the computer, a graphical representation of at least two states of the system depicted by at least one graph, the graphical representation subsystem comprising an APN subsystem that:
describes at least two places representing possible states of the multiple entities that comprise the system;
locates a first token inside of one of the at least two places thereby denoting a current realization of one of the at least two states for one of the multiple entities represented by the first token; and
connects at least one directed arc to two of the at least two places and facilitate possible movements of the first token in a direction of the said arc.

14. The system of claim 12 wherein the APN subsystem further comprises an APN subsystem that provides a directed arc from an originating place to a transition that providing a mechanism for modeling interactions among different ones of the multiple entities by either enabling or disabling the transition that the at least one directed arc terminates at depending on a number of tokens in the originating place.

15. The system of claim 13, wherein the APN subsystem further comprises an APN subsystem that:
locates at least one additional token inside one of the at least two places; and
delays movement of the first token for each enabled transition by an interval to evaluate the first token based on individual current attributes of the first token and a matching firing policy of the transition.

16. The system of claim 14, wherein the interval is deterministic and is evaluated independently of a presence or absence of tokens other than a specific token in one of the at least two places.

17. The system of claim 14, wherein the interval is non-deterministic and is evaluated independently of a presence or absence of tokens other than a specific token in one of the at least two places.

18. The system of claim 13 wherein attributes of the first token include discrete labels and continuous labels.

19. The system of claim 13, wherein the APN subsystem further comprises an APN subsystem that:
generates a collection of subnets containing at least one selected from among a group consisting of places, tokens, transitions, and triggers that is arranged in layers.

20. A non-transitory computer readable medium encoded with a program, when executed by a processor, performing a method for processing content information in an online environment, the method comprising:
producing a graphical representation of at least two states of a system depicted by at least one graph using the processor; wherein producing a graphical representation comprises:
generating a graphical representation of at least two places that describe possible states of multiple entities that comprise the system;
depicting a token that is located inside of one of the at least two places thereby denoting a current realization of one of the at least two states for an entity represented by the token; and
depicting a first directed arc that connect two of the at least two places and facilitate possible movements of tokens in a direction of the first directed arc.
